(19) United States
(12) Patent Application Publication
(10) Pub. No.: US 2008/0107861 A1
(43) Pub. Date: May 8, 2008

(54) Non-Tacky Adhesive Fastening System

(75) Inventors: Urmish Popatlal Dalal, Milford, OH (US); Robin Lynn McKiernan, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/934,406

(22) Filed: Nov. 2, 2007

Related U.S. Application Data
(60) Provisional application No. 60/856,100, filed on Nov. 2, 2006.

(51) Int. Cl. B32B 3/06; B32B 7/12

(52) U.S. Cl. 428/99; 428/195.1

(57) ABSTRACT

Non-tacky adhesive fastening systems are disclosed, which systems include non-tacky patterned adhesive systems and non-tacky three-dimensional adhesive systems. In a non-tacky adhesive fastening system, an engaging member including a non-tacky adherent is engageable with a receiving member including a non-tacky adherend. In a non-tacky patterned adhesive system, at least one of the engaging member and receiving member has the adherent/adherend disposed thereon in a patterned fashion. In a non-tacky three-dimensional adhesive system, at least one of the engaging member and receiving member includes a plurality of projections, thereby forming at least one three-dimensional adhesive surface. The non-tacky adhesive fastening systems exhibit advantageous peel characteristics and exhibit an increased resistance to contamination. The non-tacky adhesive fastening systems can be included in absorbent articles such as diapers and other consumer goods.

### CROSS REFERENCE TO RELATED APPLICATION

This application claims the benefit of U.S. Provisional Application No. 60/856,100, filed Nov. 2, 2006, the substance of which is incorporated herein by reference.

### FIELD OF THE INVENTION

The present invention generally relates to consumer goods, such as absorbent articles, and fastening systems used therewith and, more specifically, to non-tacky adhesive fastening systems having a non-tacky adherent or a non-tacky adherend in a patterned or three-dimensional configuration that may be peeled apart with a low force.

### BACKGROUND OF THE INVENTION

Fastening systems are widely used in a variety of applications where closure of components is required. Certain fastening systems are refastenable in that they are capable of multiple openings and closures. Items such as diapers and containers storing foodstuff or other consumer goods are commonly equipped with a fastening system and, typically, a refastenable fastening system. Such fastening systems may include a mechanical fastening system and/or an adhesive fastening system. While mechanical and adhesive fastening systems provide certain consumer benefits, each system also has significant drawbacks.

Mechanical fastening systems capable of refastenability include hook and loop fasteners and variants such as mushroom-shaped fasteners. Fasteners in these systems may have a tendency to attach to undesired surfaces such as clothing, carpet, or the wearer. Furthermore, hooks are generally rigid and, if used in products which are placed in close contact to a wearer's skin, may cause skin irritation. Fasteners in these systems also may become damaged during the high-speed formation process required for the commercially viable manufacture of consumer goods, such as diapers. For example, hooks tend to get damaged during manufacture, and other mechanical-type fasteners such as buttons, tab and slots, or the like can also become damaged, torn, or otherwise adversely affected by high speed handling.

Another problem associated with mechanical fasteners is that they may not be sufficiently durable for use in consumer goods. For example, disposable absorbent articles such as pant-type diapers may have sides secured by a mechanical fastener such as a hook and loop fastening system. However, hook and loop fastening systems may prove inadequate for the peel force demands of a pant-type diaper. If peel forces are too low, a child may be able to remove the diaper when such removal is undesired. Another potential drawback of conventional mechanical fasteners, particularly in pant-type diapers, is that such fasteners may need to be located in an area of the diaper without stretch properties. This may create a design limitation if the mechanical fastener is to be located in an area exhibiting stretch properties such as the side panels of a pant-type diaper. The compromise made is typically to limit the size of the hook and loop fastening area, which results in a lack of versatility of the product and can diminish the desired fastening strength of the side panels of the article.

Like mechanical fastening systems, adhesive fastening systems also have drawbacks. One such drawback of an adhesive fastening system includes the use of a traditional adhesive that sticks to surfaces indiscriminately. Such indiscriminate adhesive fastening systems disfavored in consumer products such as diapers where adhesion of the fastener to skin, hair, or clothing is undesirable.

Another drawback of adhesive fastening systems is that the system may exhibit “lock-up” after a period of time in an engaged configuration. Lock-up is the condition where an engaged fastening system will not release without some form of catastrophic failure to the adhesive fastening system that prohibits refastening. For example, the fastening system may tear or the adhesive may delaminate from an underlying substrate. In many consumer goods with an adhesive fastening system, lock-up is a significant problem because the consumer good is manufactured with the fastening system already engaged (i.e., pre-engaged). For example, an absorbent article with a pre-engaged adhesive fastening system can take the form of a pants-type diaper having refastenable side seams including an adhesive fastening system. During the manufacture, transport, and storage of pant-type diapers, a pre-engaged adhesive may be engaged for several weeks or months and may experience elevated pressure and temperature.

Time, temperature, and pressure may all exacerbate adhesive lock-up. Generally, a pre-engaged adhesive fastening system will experience environmental factors during transport and storage that far exceed the environmental factors experienced during use of the pre-engaged adhesive fastening system. For example, during transport and storage, a pre-engaged adhesive fastening system on a pants-type diaper may experience temperatures in excess of 60° C. and pressures in excess of 0.8 N/cm². Conversely, during wear, a pre-engaged adhesive fastening system on a pants-type diaper generally experiences temperatures of about 98° F. (about 37° C.) and de minimis pressures. As a result of the time, temperature, and pressure experienced by the pre-engaged adhesive fastening system, a consumer may receive a pants-type diaper with a locked adhesive fastener. The diaper would be considered undesirable because unfastening the pre-engaged system would prevent further refastenability of the diaper.

Even if lock-up does not occur, the pre-engaged adhesive fastening system may require separation forces that exceed a preferred range. Consumer testing has shown that fastening systems exhibiting a peel force of greater than about 4.7 N/cm (i.e., about 12 N/inch), as measured by a T-Peel test, are considered difficult to separate. Consumers tend to prefer a fastening system exhibiting a peel force of less than about 3.9 N/cm (i.e., about 10 N/inch), as measured by the T-Peel test.

A further drawback of pre-engaged adhesive fastening systems is that, if the system does not exhibit lock-up or require an excessive separation force, the system may exhibit poor refastenability. After a pre-engaged adhesive fastening system has been opened and refastened, the system should exhibit sufficient integrity such that it may remain engaged during normal use. The force to disengage the pre-fastened system should be sufficient to counteract the forces normally encountered during use of the article and fastening system. For pants-type diapers, the refastened adhesive fastening system should have sufficient strength to counteract normal wear forces (e.g., wearer movements) while remaining sealed, and the fastening system should be able to be refastened at least three times while maintaining sufficient strength.

Still further, adhesive fastening systems are susceptible to contaminants that can substantially reduce the adhesive strength of the adherent/adherend. Typical sources of contamination include: human hands/fingers (e.g., a source of proteins, oils, surfactants, water, skin care products, polydimethylsiloxane, etc.), other conventional adhesives (e.g., hot melt adhesives and pressure-sensitive adhesives), and the environment (e.g., dirt, dust, other airborne particulates, etc.).

While the problems associated with mechanical and adhesive fastening systems have been described thus far with respect to pant-type diapers, the problems are equally applicable to similar fastening systems on other consumer goods and commercial products. For example, the fastening system may itself be a commercial good in the form of a rollstock of pre-engaged two-component tape such as a hook-and-loop tape with a hook-bearing sheet joined to a loop-bearing sheet. The rollstock may be used by a consumer to refastenably join two surfaces together. Other consumer products having similar problems with mechanical and adhesive fastening systems include overwraps or bags where resealability is desired. For example, fastening systems are becoming increasingly common on foodstuff bags (e.g., potato chip bags and the like) and on overwraps or bags housing consumer or commercial goods (e.g., diaper overwraps, tissue overwraps, and the like).

Non-tacky adhesive fastening systems as presented herein avoid many of the problems associated with conventional mechanical fastening systems and conventional adhesive fastening systems via patterns and three dimensional configurations. For instance, non-tacky adhesive fastening systems do not have mechanical structures that can be skin-irritating, fragile, or both. Nor do these systems adhere indiscriminately to any surface.

### SUMMARY OF THE INVENTION

Accordingly, it would be desirable to provide a non-tacky adhesive fastening system that, after aging in a pre-engaged state, requires an acceptable amount of separation force. It is also desirable that the fastening system be resistant to contamination. Additionally, the fastening system should not exhibit lock-up. It is also desirable that the fastening system exhibit refastenability such that the fastening system can be opened and refastened multiple times while maintaining sufficient integrity in the refastened state. A fastening system that is pre-engaged is desirable because such a configuration shields the adhesive surface from contamination during shipment and handling.

The present disclosure in another aspect relates generally to a consumer good including a non-tacky adhesive fastening system. Such a fastening system may be useful for any product that requires (i) an initial attachment or seal and/or (ii) refastenability that maintains sufficient fastening integrity. Representative products include, but are not limited to, polymer film bags such as for diaper, wipe, or tissue containers, and disposable absorbent articles such as diapers or pull-on pants. A particular aspect of the present disclosure relates to a disposable absorbent article having a non-tacky adhesive fastening system. If pre-engaged, the system joins elements of the article so that the article may be provided to the consumer in a closed, “pant-like” configuration (i.e., the article has a complete waist opening and a pair of leg openings). In contrast, an article may be provided in an “open” configuration (i.e., the system is not pre-engaged and the article does not have a continuous waist and/or a pair of leg openings) where the consumer must engage the system to form a continuous waist and enable the article to encircle the waist and legs of a wearer. In either a closed or open form, the user may make use of the refastenability feature to (i) open the waist from a closed to open configuration or to (ii) close it from an open to closed configuration. The refastenable feature allows for such opening and closing of a portion of the article multiple times during the life cycle of the absorbent article.

By employing various types of non-tacky adhesive fastening techniques either alone or in combination with other, conventional fastening techniques in connection with the articles described herein, the articles offer improved versatility, fit, and refastening performance over those previously known in the art. These and other advantages of the present invention will become apparent in light of the description below.

One aspect of the disclosure provides a non-tacky patterned adhesive system including an engaging member having an engaging surface with a first non-tacky adherent disposed thereon, a second non-tacky adherent disposed thereon, and a non-adhesive engaging zone being substantially free from non-tacky adherents; and, a receiving member having a receiving surface with a first non-tacky adherend disposed thereon; wherein the first non-tacky adherent and second non-tacky adherent are at least partially separated from each other by the non-adhesive engaging zone; and, the engaging member is engageable with the receiving member such that the engaging surface exhibits adhesion to the receiving surface when engaged. In another embodiment, the receiving surface further includes a second non-tacky adherend disposed thereon and a non-adhesive receiving zone being substantially free from non-tacky adherends, wherein the first non-tacky adherend and second non-tacky adherend are at least partially separated from each other by the non-adhesive receiving zone. In yet another embodiment, the engaging surface can include a plurality of non-tacky adherents and a plurality of non-tacky adherends.

Another aspect of the disclosure provides an absorbent article including an absorbent assembly with a topsheet, a backsheet, an absorbent core disposed between the topsheet and backsheet, a front waist region, a rear waist region, and a crotch region between and connecting the front waist region and the rear waist region; a side panel disposed between and connecting the front waist region and the rear waist region; and, a non-tacky patterned adhesive system with an engaging member including a patterned engaging surface having a non-tacky adherent disposed thereon and with a receiving member including a receiving surface having a non-tacky adherend disposed thereon; wherein at least one of the engaging member and the receiving member is disposed on the side panel. In another embodiment, the absorbent article includes, in place of the side panel, a waistband having an interior surface, an exterior surface, a front region, a rear region, and an elastic element; wherein the waistband defines a waist opening, at least one of the engaging member and the receiving member is disposed on the front region of the waistband; and, at least one of the engaging member and the receiving member is disposed on the front waist region of the absorbent assembly.

Another aspect of the disclosure provides an article of commerce including at least one commercial good; an overwrap partially or fully enclosing said commercial good, the overwrap having an opening through which the commercial good may be removed, a first overwrap area, and a second overwrap area; and, a non-tacky patterned adhesive system including an engaging member with a patterned engaging surface having a non-tacky adherent disposed thereon and a receiving member with a receiving surface having a non-tacky adherend disposed thereon; wherein at least one of the engaging member and the receiving member is disposed on the first overwrap area; and, at least one of the engaging member and the receiving member is disposed on the second overwrap area.

Another aspect of the disclosure provides a non-tacky three-dimensional adhesive system including an engaging member having an engaging surface, a plurality of engaging projections disposed on the engaging surface, a plurality of engaging recessions defined by the plurality of engaging projections, and a non-tacky adherent disposed on at least one of the engaging surface and the plurality of engaging projections; and, a receiving member including a receiving surface having a non-tacky adherend disposed thereon; wherein the engaging member is engageable with the receiving member such that the engaging surface exhibits adhesion to the receiving surface when engaged. In another embodiment, the receiving member instead includes a receiving surface, a plurality of receiving projections disposed on the receiving surface, a plurality of receiving recessions defined by the plurality of receiving projections, and a non-tacky adherend disposed on at least one of the receiving surface and the plurality of receiving projections, wherein the engaging member is engageable with the receiving member such that the engaging surface exhibits adhesion to the receiving surface when engaged.

Another aspect of the disclosure provides an absorbent article including an absorbent assembly with a topsheet, a backsheet, an absorbent core disposed between the topsheet and backsheet, a front waist region, a rear waist region, and a crotch region between and connecting the front waist region and the rear waist region; and, a side panel disposed between and connecting the front waist region and the rear waist region; and, a non-tacky three-dimensional adhesive system with an engaging member including a three-dimensional engaging surface having a non-tacky adherent disposed thereon and with a receiving member including a receiving surface having a non-tacky adherend disposed thereon; wherein at least one of the engaging member and the receiving member is disposed on the side panel. In another embodiment, the absorbent article includes, in place of the side panel, a waistband having an interior surface, an exterior surface, a front region, a rear region, and an elastic element; wherein the waistband defines a waist opening, at least one of the engaging member and the receiving member is disposed on the front region of the waistband; and, at least one of the engaging member and the receiving member is disposed on the front waist region of the absorbent assembly.

Another aspect of the disclosure provides an article of commerce including at least one commercial good; an overwrap partially or fully enclosing said commercial good, the overwrap having an opening through which the commercial good may be removed, a first overwrap area, and a second overwrap area; and, a non-tacky three-dimensional adhesive system including an engaging member with a three-dimensional engaging surface having a non-tacky adherent disposed thereon and a receiving member with a receiving surface having a non-tacky adherend disposed thereon; wherein at least one of the engaging member and the receiving member is disposed on the first overwrap area; and, at least one of the engaging member and the receiving member is disposed on the second overwrap area.

### BRIEF DESCRIPTION OF THE DRAWINGS

FIG. 1A is a plan view of a non-tacky patterned adhesive system.

FIG. 1B is a cross-sectional view of the non-tacky patterned adhesive system of FIG. 1A taken along sectional line 2-2.

FIG. 1C is a plan view of an engaging member and an opposing receiving member in a non-tacky patterned adhesive system.

FIG. 1D is a plan view of an engaging member and an opposing receiving member of an alternate non-tacky patterned adhesive system.

FIG. 1E is a plan view of an engaging member and an opposing receiving member of an alternate non-tacky patterned adhesive system.

FIG. 1F is a plan view of an engaging member and an opposing receiving member of an alternate non-tacky patterned adhesive system.

FIG. 1G is a plan view of an engaging member and an opposing receiving member of an alternate non-tacky patterned adhesive system.

FIG. 1H is a graph of the force-distance peel behavior for the non-tacky patterned adhesive system of FIG. 1C.

FIG. 1I is a graph of the force-distance peel behavior for the non-tacky patterned adhesive system of FIG. 1E.

FIG. 1J is a graph of the force-distance peel behavior for the non-tacky patterned adhesive system of FIG. 1G.

FIG. 2A is a cross-sectional view of a non-tacky three-dimensional adhesive system.

FIG. 2B is a cross-sectional view of the non-tacky three-dimensional adhesive system of FIG. 2A in an engaged state.

FIG. 2C is a cross-sectional view of an alternate non-tacky three-dimensional adhesive system.

FIG. 2D is a cross-sectional view of alternate cross-sectional shapes for the projections of FIGS. 2A to 2C.

FIG. 2E is a perspective view of a non-tacky three-dimensional adhesive system.

FIG. 2F is a perspective view of an alternate non-tacky three-dimensional adhesive system.

FIG. 3 is a perspective view of a rollstock of two-component tape including a non-tacky adhesive system.

FIG. 4A is a perspective view of an absorbent article including a non-tacky adhesive system.

FIG. 4B is a perspective view of the absorbent article of FIG. 4A with the non-tacky adhesive system partially separated.

FIG. 4C is a perspective view of another embodiment of an absorbent article with a non-tacky adhesive system partially separated.

FIG. 4D is a perspective view of another embodiment of an absorbent article with a non-tacky adhesive system partially separated.

FIG. 5A is a perspective view of another embodiment of an absorbent article with a non-tacky adhesive system partially separated.

FIG. 5B is a plan view of the absorbent article of FIG. 5A.

FIG. 6A is a partial cut-away perspective view of an article of commerce having a non-tacky adhesive system.

FIG. 6B is a perspective view of the article of commerce of FIG. 6A with the non-tacky adhesive system separated.

FIG. 7A is a partial cut-away perspective view of another embodiment of an article of commerce having a non-tacky adhesive system.

FIG. 7B is a perspective view of the article of commerce of FIG. 7A with the non-tacky adhesive system separated.

FIG. 8A is a plan view of a representative sample for the T-Peel test.

FIG. 8B is a sectional view of the sample of FIG. 8A taken along sectional line b-b.

FIG. 8C is a partial cross-sectional view of the sample of FIG. 8A in a set of tensile tester grips.

FIG. 9A is a plan view of a representative sample for the Dynamic Shear test.

FIG. 9B is a sectional view of the sample of FIG. 9A taken along sectional line b-b.

FIG. 9C is a cross-sectional view of the sample of FIG. 9A in a set of tensile tester grips.

FIG. 10A is a plan view of a representative sample for the Shear Hang Time test.

FIG. 10B is a sectional view of the sample of FIG. 10A taken along sectional line b-b.

FIG. 10C is a cross sectional view of the sample of FIG. 10A in a test apparatus.

FIG. 11 depicts a suitable sample and instrument configuration for the Probe Tack Test.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

### DETAILED DESCRIPTION OF THE INVENTION

### Definitions

As used herein, the term “absorbent article” refers to a device that absorbs and contains liquid, and more specifically, refers to a device that is placed against or in proximity to the body of the wearer to absorb and contain the various exudates discharged from the body. Absorbent articles include items such as diapers, pull-on diapers or pant-type garments, training pants, incontinence briefs, incontinence undergarments, absorbent inserts, diaper holders and liners, feminine hygiene garments, and the like.

As used herein, the term “longitudinal” refers to a direction running perpendicular from a waist edge to an opposing waist edge of the article and generally parallel to the maximum linear dimension of the article. Directions within 45 degrees of the longitudinal direction are considered to be “longitudinal.”

As used herein, the term “lateral” refers to a direction running from a side edge to an opposing side edge of the article and generally at a right angle to the longitudinal direction. Directions within 45 degrees of the lateral direction are considered to be “lateral.”

As used herein, the term “disposable” is used to describe absorbent articles that generally are not intended to be laundered or otherwise restored or reused as an absorbent article (i.e., they are intended to be discarded after a single use and, preferably, to be recycled, composted or otherwise disposed of in an environmentally compatible manner).

As used herein, the terms “elastic,” “elastomer,” and “elastomeric” refer to a material which generally is able to extend to a strain of at least 50% without breaking or rupturing, and is able to recover substantially to its original dimensions after the deforming force has been removed.

As used herein, the term “body-facing” is used to describe a surface that is in contact with the body of a wearer or in close proximity (i.e., closer to the body than a garment-facing surface) to the body of the wearer when the article is worn.

As used herein, the term “garment-facing” is used to describe a surface that is in contact with or may be in close proximity to any garment being worn.

As used herein, the term “disposed” is used to mean that an element(s) is formed (joined and positioned) in a particular place or position as a unitary structure with other elements or as a separate element joined to another element.

As used herein, the term “joined” encompasses configurations whereby an element is directly secured to another element by affixing the element directly to the other element, and configurations whereby an element is indirectly secured to another element by affixing the element to intermediate member(s) which, in turn, are affixed to the other element.

As used herein, the term “pant-type” refers to an article configured such that it has a waist opening and a pair of leg openings. A pant may be placed in position on the wearer by inserting the wearer's legs into the leg openings and sliding the pant into position about a wearer's lower torso. This configuration may be permanent as in the case of conventional underwear, or may be temporary as in the case of a training pant with openable seams for removal. Additionally, absorbent articles can be constructed with refastenable features allowing the article to have both a pant-like configuration and one or more configurations which are open or not pant like.

As used herein the term “refastenable” refers to the attachment of two or more elements or portions of elements together in a manner in which they can be separated and re-attached without substantial degradation of fastener performance or damage to surrounding components of the article which would impair the article's continued use. It will be appreciated that a refastenable component need not have an infinite life span, but it is sufficient that the components attached in a refastenable manner can be separated and re-attached successively several times over the typical use life span of the article. It will also be appreciated that the aggressiveness of actual fastening may be reduced significantly from fastening to refastening in absolute terms, but that such reduction is not “substantial degradation” of fastener performance if the resulting refastened strength is sufficient for the fastening system's purpose of use.

As used herein, the term “refastening event” refers to the separating and reengaging of an engaged fastening system.

As used herein, “lock-up” refers to the condition where an engaged fastening system will not release without some form of catastrophic failure that prohibits refastening.

As used herein “permanent bond” refers to attachment of two or more elements or portions of elements together in a manner in which they are not intended to be separated during normal use of the article. Separation of such a permanent bond results in degradation of the attachment and/or of portions of the article. The performance of the article for its intended use is compromised upon breaking of a permanent bond.

As used herein, “adhesive fastening system” or simply “adhesive system” refers to a fastening system utilizing a traditional adhesive, a selective adhesive, or a cohesive for adhesion.

As used herein the term “mechanical fastener” refers to a fastening system or mechanism relying on physical restraint, magnetic fields, or engagement of portions of the fastener for operation. Examples of mechanical fasteners are hook-and-loop, hook-and-hook, buttons, snaps, tab-and-slot, zippers, magnet(s), and tongue-in-groove fasteners.

As used herein, the terms “typical adhesive” and “traditional adhesive” are interchangeable and refer to an adherent which demonstrates adhesion when applied to another material generally (e.g. material is not specially selected). Traditional adhesive materials connect to other materials indiscriminately and may stick to a variety of materials. Traditional adhesives are tacky. Generally, typical adhesive materials used in disposable absorbent articles demonstrate adhesion either at certain temperatures (such as a hot melt adhesive) or under pressure (a pressure sensitive adhesive).

As used herein, the term “oriented” refers to a polymer material that has been strained during manufacture to substantially align the molecular chains. “Bi-oriented” refers to a material that has been strained during manufacture in two directions; generally, the two directions are orthogonal to each other.

As used herein, the term “cohesive” refers to a material that demonstrates surface interaction (in terms of connection of one surface to another) when applied to itself or to an analog of itself (i.e., the same or essentially the same material is both the adherent and adherend). An A-A type cohesive material will fasten or form a connection primarily to itself. Generally, such cohesives are substantially non-tacky (such as to skin) at room temperature or while under moderate pressure (e.g., finger pinch pressure).

As used herein, the term “selective adhesive” refers to an adherent which demonstrates surface interaction (in terms of connection of one surface to another) when applied to a specially selected adherend. An A-A′ type selective adhesive system demonstrates surface interaction where adherent A will stick to adherend A′, where A′ is a material that is chemically similar to A. An A-B type selective adhesive system demonstrates surface interaction properties where adherent A will stick to a different material, adherend B. However, A′ may also be a cohesive. For example, in an A-A′ type selective system, A may also attach to A, and A′ may attach to A′. In another example, an A-B type selective adhesive system could also exist where an material A may attach to itself or to material B, but material B will not attach to itself. The adherent and adherend of selective adhesives can be non-tacky.

As used herein the term “non-tacky” refers to an adherent or adherend that exhibits low surface adhesion to skin as measured by Probe Tack Test Method described below. Low surface adhesion is quantified as a measurement of less than 50 grams force (gf) per cm², according to the Probe Tack Test Method. In certain embodiments, low surface adhesion may be less than 40 gf/cm²; alternately, less than 30 gf/cm²; alternately, less than 20 gf/cm²; alternately, less than 10 gf/cm²; or alternately, less than 5 gf/cm². Conversely, “tacky” is mutually exclusive with “non-tacky” and refers to an adherent or adherend that exhibits a surface adhesion to skin of greater than 50 gf/cm² as measured by Probe Tack Test Method.

As used herein the term “dwell time” refers to the time a fastening system remains engaged. Generally, the dwell time is the time a fastening system remains engaged prior to some testing of the engaged fastening system.

As used herein the term “aging” refers to the process by which a fastening system (i.e., typically a pre-engaged fastening system) remains engaged over some period of time. Aging may occur when (i) a pre-engaged fastening system is engaged for approximately 15 days after manufacture, or (ii) a fastening system is initially engaged and then subjected to an accelerated aging process. Similarly, the term “aged” refers to a fastening system (i.e., typically a pre-engaged fastening system) that has been subjected to aging.

As used herein, “accelerated aging process” refers to an engaged fastening system being subjected to a temperature of 60° C. and an evenly distributed pressure of 0.8 N/cm² for at least six hours. The accelerated aging process may be prolonged to seven days or more; however, unless specifically designated otherwise, accelerated aging is performed for three days. Unless otherwise stated, values obtained via the T-Peel Test, the Dynamic Shear Test, and the Shear Hang Time test involve samples that have undergone an accelerated aging process. The accelerated aging process is believed to simulate the effect of aging the engaged fastening system for several weeks after manufacture (e.g., while the product is stored, transported, etc.).

As used herein the term “extensible” refers to materials which elongate or increase in at least one dimension when subject to an external pulling force.

As used herein the terms “stretchable” or “elastic” refer to materials which are extensible and which also return to substantially their original dimensions when the external pulling force is removed. It will be appreciated that the terms “stretchable” and “elastic” include the term “extensible” as each term is used herein.

As used herein the term “pre-engaged” refers to a fastening system that is manufactured so that elements of the non-tacky adhesive fastening system are engaged, affixed, or otherwise stuck together.

As used herein the term “non-tacky adhesive system” (or “NT adhesive system”) refers to both a non-tacky patterned adhesive system and a non-tacky three-dimensional adhesive system described in more detail below. Both NT adhesive systems utilize selective adhesives or cohesives. Where a particular article is described as having a non-tacky adhesive system, either (or both in combination) the non-tacky patterned adhesive system or the non-tacky three-dimensional adhesive system may be integrated into the article.

### Non-Tacky Patterned Adhesive System

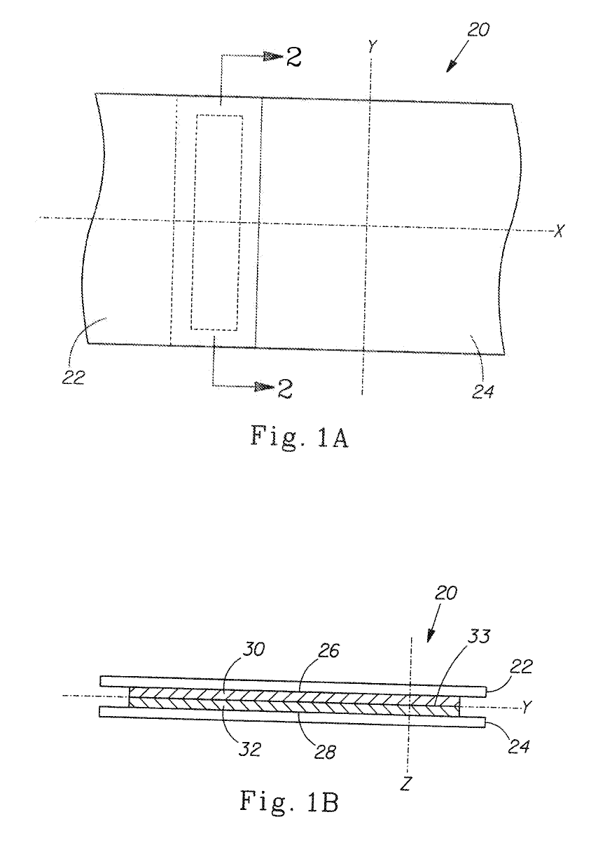

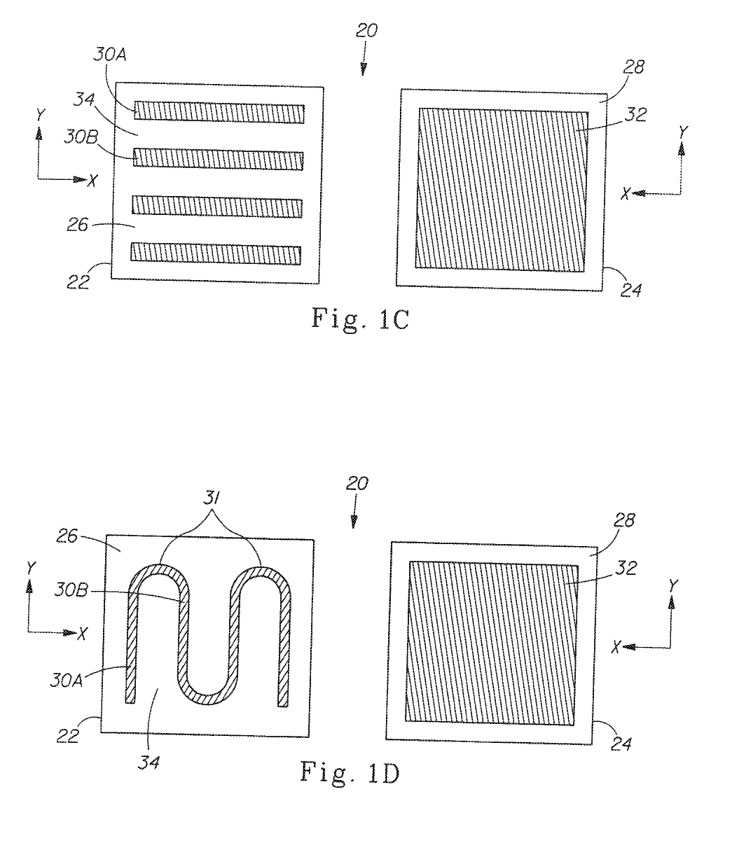

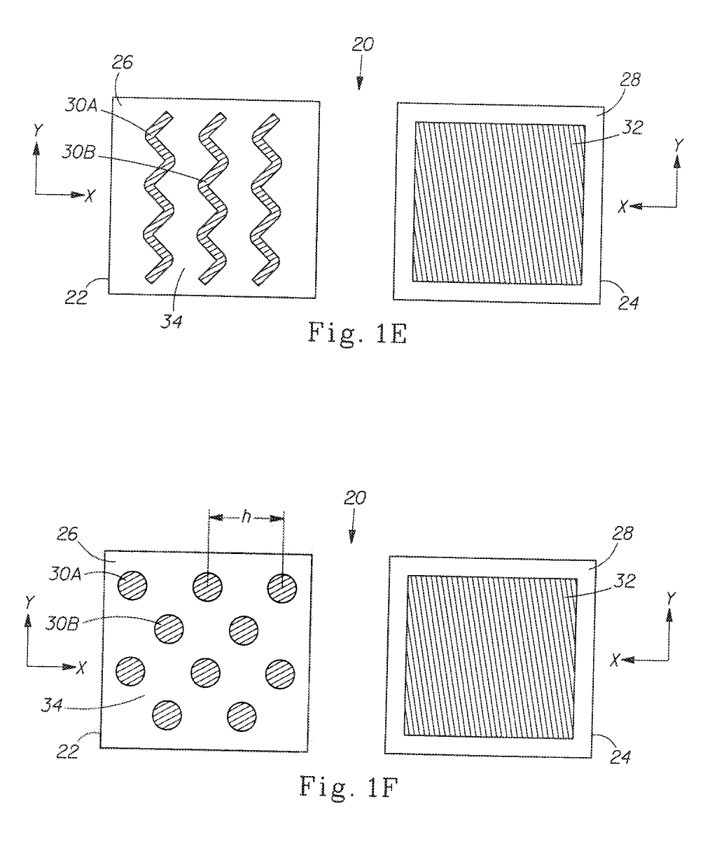

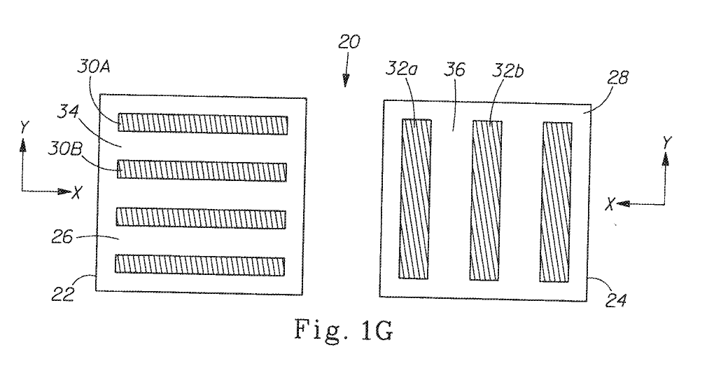

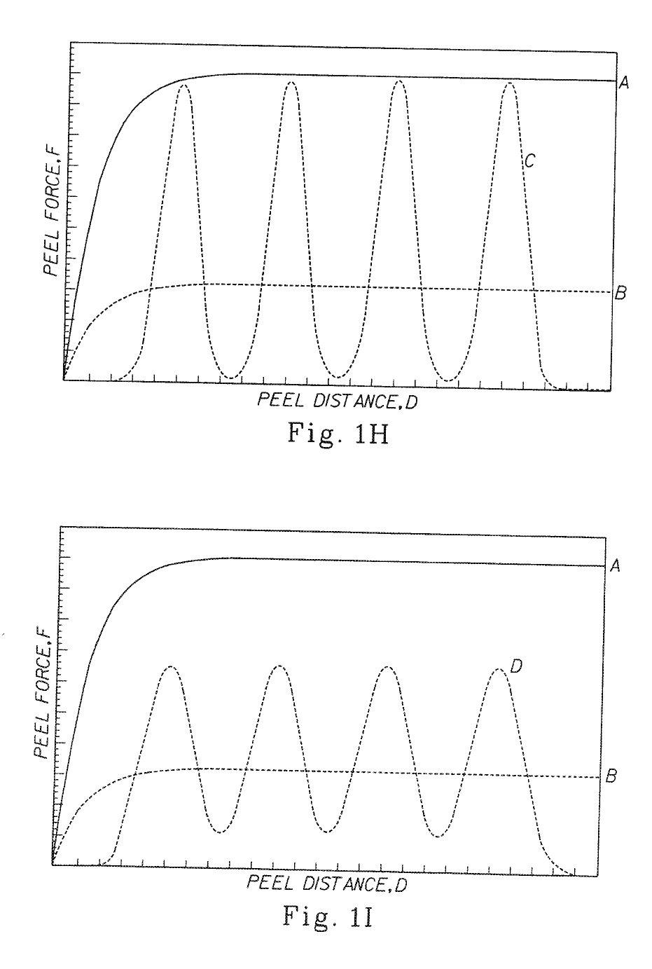

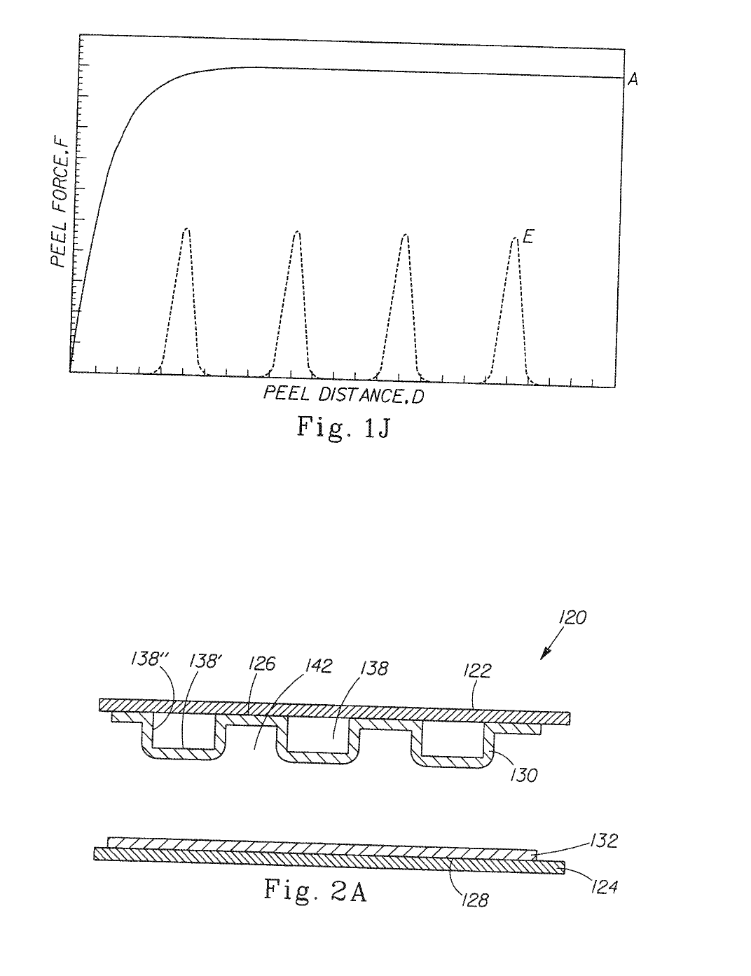

FIGS. 1A to 1J illustrate one aspect of the NT adhesive system from the present disclosure: a non-tacky patterned (NTP) adhesive system. A benefit of using an NTP adhesive system is that it allows the use of adhesive systems having higher peel forces (i.e., greater than 3.1 N/cm) than consumers traditionally desire because the average peel force of the adhesive system is within a consumer acceptable range (i.e., from about 0.8 N/cm to about 3.1 N/cm). As said above, adhesive fastening systems are susceptible to contaminants that can substantially reduce the peel force of the adhesive system. NTP adhesive systems, however, can mitigate this reduction in average peel force because it uses localized sites having a higher peel force.

FIG. 1A shows an embodiment of an NTP adhesive system 20 according to the present disclosure. FIG. 1B shows a cross-sectional view of FIG. 1A taken along sectional line 2-2. The NTP adhesive system 20 generally includes an engaging member 22 and a receiving member 24. The engaging member 22 has an engaging surface 26 with a non-tacky (NT) adherent 30 disposed thereon. The receiving member 24 has a receiving surface 28 with a non-tacky (NT) adherend 32 disposed thereon. In an engaged state, the engaging surface 26 of the engaging member 22 is in a planar face-to-face relation to the receiving surface 28 of the receiving member 24. The engaging member 22 is engageable with the receiving member 24, and both are positioned so the NT adherent 30 and the NT adherend 32 contact one another to define an interface 33, thereby exhibiting adhesion between engaging surface 26 and the receiving surface 28. The NT adherent 30 and the NT adherend 32 interact so as to join the engaging member 22 and the receiving member 24. In the illustrated engaged state, the NT adherent 30 and the NT adherend 32 overlap completely at the interface 33. However, such a configuration is not required; in general, the interface 33 between the NT adherent 30 and the NT adherend 32 may be non-coterminous with the engaging surface 26, the receiving surface 28, the NT adherent 30 and/or the NT adherend 32.

The NTP adhesive system 20 is generally coplanar with an xy-plane as shown in FIG. 1A. The NTP adhesive system 20 may have some caliper, or thickness, in the z-direction (as shown in FIG. 1B) perpendicular to the xy-plane. As will be appreciated in the description provided below, the NTP adhesive system 20 may experience a shear force that generally may be directed along any vector in the xy-plane. As will be further appreciated in the description provided below, the NTP adhesive system 20 may experience a peel force that generally may be directed along the z-axis when the engaging member 22 and the receiving member 24 are disengaged via a peeling motion.

The patterning of the adhesive system, not visible in the plan and cross-sectional views of FIGS. 1A and 1B, is illustrated in FIGS. 1C to 1G. Each of FIGS. 1C to 1G presents a top view of adhesive sides of the engaging member 22 and the receiving member 24 for various exemplary patterns. The sides visible in the FIGS. 1C to 1G are the sides that meet in a face-to-face relation at the interface 33 when the NTP adhesive system 20 is in an engaged configuration.

FIG. 1C illustrates an embodiment of the NTP adhesive system 20 in which only one of the opposing members has a patterned adhesive layer. The engaging member 22 generally has an engaging surface 26. The engaging surface 26 has a plurality of NT adherents 30 disposed thereon, including, for example, a first NT adherent 30A and a second NT adherent 30B. As shown in FIG. 1C, the first NT adherent 30A and the second NT adherent 30B are arranged relative to each other in a substantially linear and substantially parallel fashion. However, as illustrated below, such an arrangement is not required. The receiving member 24 of FIG. 1C has a receiving surface 28 upon which a single NT adherend 32 is disposed.

The engaging member 22 also includes at least one non-adhesive engaging zone 34 that is substantially free from any NT adherents. In FIG. 1C, the NT adherents 30 (e.g., the first and second NT adherent 30A and 30B, respectively) are arranged such that they are completely separated from each other by the non-adhesive engaging zone 34. However, as illustrated below, complete separation is not required, and the NT adherents 30 generally need only be partially separated from each other by the non-adhesive engaging zone 34.

FIG. 1D illustrates another embodiment of the NTP adhesive system 20, wherein the various NT adherents 30 (e.g., the first and second NT adherents 30A and 30B, respectively) are only partially separated from each other by the non-adhesive engaging zone 34. Similar to the embodiment illustrated in FIG. 1C, the receiving member 24 has a receiving surface 28 upon which a NT adherend 32 is disposed. In the illustrated embodiment, the first NT adherent 30A and the second NT adherent 30B are arranged relative to each other in a substantially linear and substantially parallel fashion. However, the NT adherents 30 actually represent a continuous adherent whose arrangement is made possible by adherent turns 31.

FIG. 1E illustrates an embodiment of the NTP adhesive system 20 in which the various NT adherents 30 (e.g., the first and second NT adherents 30A and 30B, respectively) are not substantially linear. As in FIG. 1C, the NT adherents 30 are completely separated from each other by the non-adhesive engaging zone 34. The configuration shown in FIG. 1E may provide the benefit of reducing the peak peel resistance while maintaining the net T-Peel force in a desirable range, as discussed below with reference to FIGS. 1H to 1J. Similar to the embodiments illustrated in FIGS. 1C and 1D, the receiving member 24 has a receiving surface 28 upon which a NT adherend 32 is disposed.

FIG. 1F illustrates an embodiment of the NTP adhesive system 20 in which the various NT adherents 30 (e.g., the first and second NT adherent 30A and 30B, respectively) are discrete circular shapes arranged on a regular hexagonal lattice and completely separated from each other by the non-adhesive engaging zone 34. Other shapes (e.g., discrete rectangles, etc.) and patterns (e.g., rectangular lattice) are possible. The configuration shown in FIG. 1F may have the benefit of providing a more isotropic force-distance peel behavior for the NTP adhesive system 20 when only one of the opposing members is patterned with an adherent/adherend. In the illustrated embodiment, the receiving member 24 has a receiving surface 28 upon which a NT adherend 32 is disposed.

In an alternate embodiment (not shown), the receiving member 24 of FIG. 1F may have a plurality of NT adherends (e.g., first and second NT adherends) that are shaped and arranged in a pattern complementary to the pattern on the engaging member 22. In this alternate embodiment, there is generally overlap only among corresponding engaging/receiving surface pairs when the NTP adhesive system 20 is engaged. For instance, when engaged, the first NT adherent 30A contacts only the first NT adherend (not shown) and the second NT adherent 30B contacts only the second NT adherend (not shown).

FIG. 1G illustrates an embodiment in which both opposing members of the NTP adhesive system 20 have patterned surfaces. Similar to FIG. 1C, the engaging surface 26 of engaging member 22 has a plurality of NT adherents 30 (e.g., first and second NT adherents 30A and 30B, respectively) disposed thereon. In contrast to FIG. 1C, the receiving member 24 has receiving surfaces 28 with a plurality of NT adherends 32 (e.g., first and second NT adherends 32A and 32B, respectively) disposed thereon. As shown in FIG. 1G, neighboring NT adherents 30 (e.g., 30A and 30B) are substantially linear and substantially parallel to each other, and neighboring NT adherends 32 (e.g., 32A and 32B) are also substantially linear and substantially parallel to each other. Moreover, the NT adherents 30 are substantially orthogonal to the NT adherends 32 when engaged. However, such an arrangement is not required in the two-pattern system shown in FIG. 1G. As a result, the NT adherent 30 and the NT adherend 32 may be in any orientation relative to each other.

In the embodiment shown in FIG. 1G, the engaging member 22 includes at least one non-adhesive engaging zone 34 that is substantially free from any NT adherents, and the receiving member 24 includes at least one non-adhesive receiving zone 36 that is substantially free from any NT adherends. As illustrated, neighboring NT adherents 30 and neighboring NT adherends 32 are completely separated on their respective members by the non-adhesive engaging zone 34 and the non-adhesive receiving zone 36, respectively. In general, however, partial separation (as illustrated in FIG. 1D, for example) is sufficient to achieve the benefits of the NTP adhesive system.

FIGS. 1H to 1J qualitatively illustrate a segment of the expected force-distance peel behavior of NTP adhesive systems. The curves represent the peel force required to disengage opposing engaging and receiving surfaces as a function of peel distance, where a zero peel distance represents the fully engaged state, just prior to peeling. High peak values in the curves represent barriers to inadvertent disengagement of an adhesive system. Similarly, successive peak-and-valley curves represent adhesive systems that are less susceptible to the undesirable “pop-opening” mechanism whereby an initial, partial disengagement of the system quickly propagates to complete (and possibly unintended) disengagement. The total area under the force-distance curves represent the total energy to disengage an adhesive system, which correlates to the perception of the consumer regarding the difficulty in peeling the adhesive system. In general, consumers prefer force-distance curves with high peak values (to prevent inadvertent opening and pop-opening) and integral values low enough to achieve consumer-friendly average T-Peel forces (e.g., less than about 4.7 N/cm when integrated into a NTP adhesive system).

In each of FIGS. 1H to 1J, the solid curve A represents the force-distance peel behavior for a non-patterned adhesive system in which both the engaging member and receiving member are uniformly coated with a NT adherent and a NT adherend, respectively. For some adherent/adherend pairs, a high maximum force may be sufficient to prevent inadvertent opening and pop-opening, but the substantially constant force-distance behavior can result in undesirable, excessive T-Peel forces (i.e., greater than about 4.7 N/cm when integrated into a NTP adhesive system). The dashed curves in FIGS. 1H to 1J represent the force-distance curves of the various NTP adhesive systems disclosed herein, and further illustrate the potential of the NTP adhesive system to attenuate T-Peel forces to a desirable range while maintaining desirable barrier properties.

FIG. 1H qualitatively illustrates the force-distance peel behavior for the NTP adhesive system shown in FIG. 1C. Curves B and C represent the behavior when peeled in the y- and x-directions, respectively. The curves are attenuated relative to curve A because the total engagement surface area (i.e., those parts containing the NT adherents 30) on the engaging member 22 is reduced. Curve B has a substantially constant maximum value because the relative contact area between adherent and adherend at the peel interface is uniform in the x-direction. Curve C has a peak-and-valley shape because the relative contact area between adherent and adherend at the peel interface alternates in the y-direction from regions of almost complete contact across the interface to regions where the adherent is absent. This arrangement can be desirable when the NTP adhesive system is integrated into an article (e.g., the ears of a diaper) with an orientation such that the y-direction resists inadvertent disengagement (e.g., by a child wearing the diaper) and further such that the x-direction provides a preferred peel direction (e.g., for a caregiver removing the diaper) having low peel barrier forces.

FIG. 1I qualitatively illustrates the force-distance peel behavior for the NTP adhesive system shown in FIG. 1E. Curves B and D represent the behavior when peeled in the x- and y-directions, respectively. The curves are attenuated relative to curve A for the reasons described above. Curve B exhibits substantially the same behavior as in FIG. 1H. Curve D is similar to curve C of FIG. 1H, but has relatively broader, lower amplitude peaks because the relative contact area between adherent and adherend across the peel interface gradually passes through a local maximum in regions of contact. This is in contrast to the step-function profile in the relative contact area for curve C of FIG. 1H. Relative to the embodiment shown in FIG. 1C, the configuration shown in FIG. 1E can be desirable because it provides a method of attenuating both the peak barrier forces and the average T-Peel forces.

FIG. 1J qualitatively illustrates the force-distance peel behavior for the NTP adhesive system shown in FIG. 1G. Curve E represents the behavior when peeled either in the x- or y-direction. The curve is attenuated relative to curve A for the reasons described above. Curve E has the familiar peak-and-valley shape in both the x- and y-directions based on alternating regions of adherent/adherend contact across the peel interface in both directions. Curve E is also attenuated relative to Curve C (of FIG. 1H) because there is no complete contact across the peel interface between the adherent and adherend during a peel from any direction. This configuration can be desirable because it improves the relative isotropy of the force-distance peel curve and can therefore provide advantageous peak barrier forces regardless of peel direction. Although not shown, the NTP adhesive system shown in FIG. 1F would be expected to have similar isotropic improvements in the force-distance peel behavior. For example, when peeled in the x-direction, the y-direction, or in directions displaced ±30° from the y-axis, the peel interface regularly alternates between regions of at least partial contact and regions of no contact between adherent and adherend.

From the foregoing, it is apparent that the various embodiments provide a versatile means to tailor a NTP adhesive system to a variety of physical applications and adherent/adherend pairs, thereby providing an adhesive system that has desirable peak barrier forces and average T-Peel forces.

### Non-Tacky Three-Dimensional Adhesive System

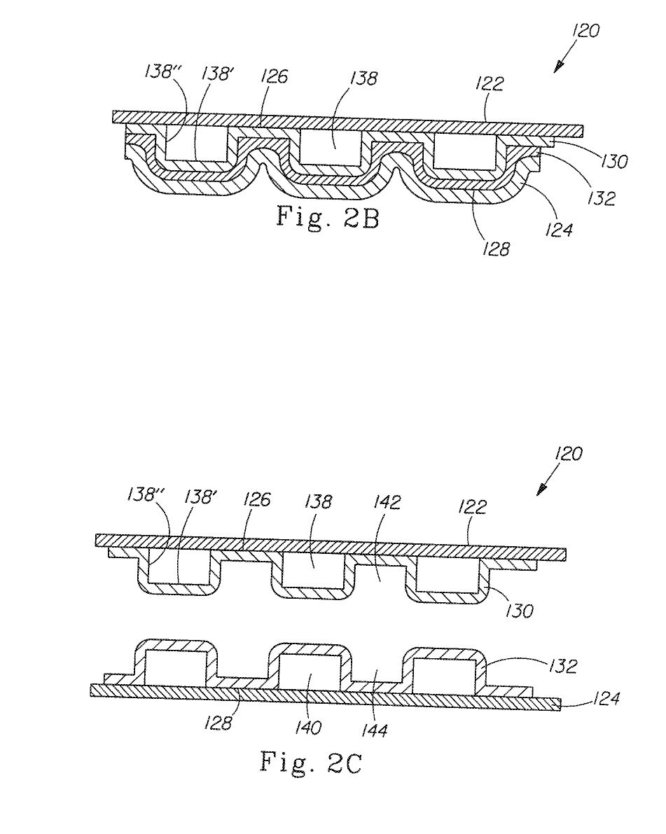

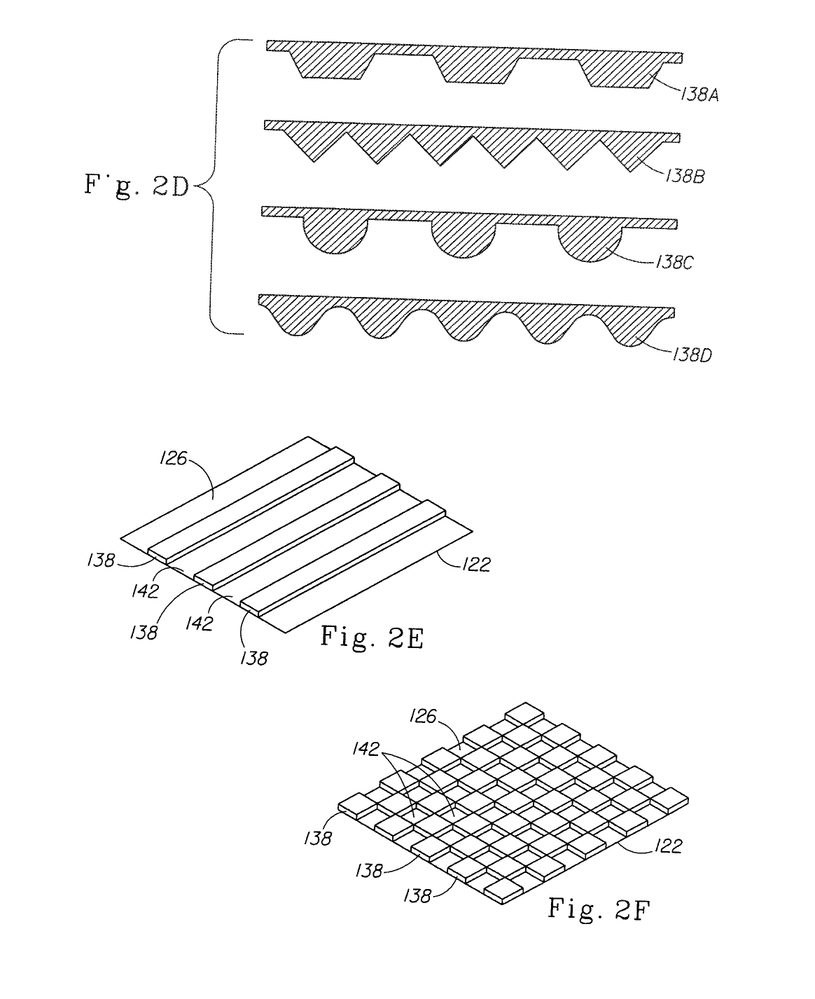

FIGS. 2A to 2F illustrate another aspect of the non-tacky adhesive fastening system from the present disclosure: namely, a non-tacky three-dimensional (NT3) adhesive system.

FIG. 2A shows an embodiment of an NT3 adhesive system 120 according to the present disclosure. The NT3 adhesive system 120 generally includes an engaging member 122 and a receiving member 124. The engaging member 122 has an engaging surface 126, upon which a plurality of engaging projections 138 are disposed. The plurality of engaging projections 138 defines a plurality engaging recessions 142 in the interstitial regions bounded by the engaging projections 138 and the engaging surface 126. In the embodiment shown, a NT adherent 130 is disposed on the exposed portions of both the engaging projections 138 and the engaging surface 126. In general, however, the NT adherent 130 need only be disposed on one of the engaging projections 138 and the engaging surface 126. Additionally, when the NT adherent 130 is disposed on a component, it may be disposed on only a portion of that component. For example, when the NT adherent 130 is disposed on the engaging projections 138, it may be coated only on the outer engaging surfaces 138″ or only on the side engaging surfaces 138″. The receiving member 124 has a receiving surface 128 with a NT adherend 132 disposed thereon.

The engaging member 122 is engageable with the receiving member 124 such that, in an engaged state, the engaging surface 126 and the outer engaging surfaces 138′ of the engaging member 122 are in a planar face-to-face relation to the receiving surface 128 of the receiving member 124. If both the engaging member 122 and the receiving member 124 are relatively rigid, non-deformable bodies, then only the NT adherent 130 that is disposed on the outer engaging surfaces 138′ contacts the NT adherend 132, thereby exhibiting adhesion between the NT adherent 130 and the NT adherend 132 when the NT3 adhesive system is in an engaged state.

In a preferred embodiment, at least one of the engaging member 122 and the receiving member 124 are deformable. FIG. 2B illustrates an embodiment in which the receiving member 124 is deformable and the engaging member 122 is non-deformable. In this case, the receiving member 124 deforms such that portions of the receiving surface 128 enter the engaging recessions 142 when engaged, thereby exhibiting adhesion between the NT adherend 132 and the NT adherent 130 on any coated surface (i.e., the engaging surface 126, the outer engaging surfaces 138′, and/or the side engaging surfaces 138″). In an alternate embodiment (not shown), the receiving member 124 is non-deformable and the engaging member 122 is deformable, such that a portion of the engaging surface 126 can deform into the engaging recessions 142 and contact the NT adherend 132, thereby exhibiting adhesion when engaged. In yet another alternate embodiment (not shown), the receiving member 124 and the engaging member 122 are both deformable, such that a portion of each can come into contact in the engaging recessions 142.

FIG. 2C illustrates another embodiment in which both opposing members of the NT3 adhesive system have three-dimensional contours. The engaging member 122 is the same as described above. The receiving member 124 is analogous to the engaging member 122, having a receiving surface 128 with a plurality of receiving projections 140 disposed thereon, which receiving projections 140 define a plurality of receiving recessions 144. Similarly, there is a NT adherend 132 disposed on at least one of the receiving surface 128 and receiving projections 140, and all or a portion of each component may be coated with the NT adherend 130.

In the embodiment shown in FIG. 2C, the engaging member 122 and the receiving member 124 may be deformable to the extent required to permit peeling disengagement of the NT3 adhesive system, but need not be deformable to the extent illustrated in FIG. 2B. In this embodiment, engaging projections 138 and the receiving projections 140 create a complementary three-dimensional geometry such that the engaging projections 138 intermesh with the receiving recessions 144 and the receiving projections 140 intermesh with the engaging recessions 142 when the NT3 adhesive system is engaged.

While FIGS. 2A to 2C illustrate engaging and receiving projections that have a generally rectangular cross-section, the NT3 adhesive system is not limited to this particular geometric contour. FIG. 2D illustrates other possible cross-sectional shapes for the engaging and receiving projections, including: trapezoidal projections 138A, triangular projections 138B, semi-cylindrical or hemispherical projections 138C, and corrugated projections 138D. Other suitable cross-sectional shapes (not shown) include mushroom-shaped projections and random polygonal projections. In general, any projection geometry that creates complementary, intermeshing opposing structures on the engaging member 122 and the receiving member 124 is suitable. While the complementary, intermeshing opposing structures can be the same shape, they may also be different shapes. For example, trapezoidal projections that form triangular recessions can be used on the engaging member 122, and triangular projections that form trapezoidal recessions can be used on the engaging member 124. These alternate cross-sectional shapes are appropriate for the embodiments in which either one or both of the engaging member 122 and the receiving member 124 have a three-dimensional contour.

FIGS. 2E and 2F provide perspective views of the NT3 adhesive system, illustrating an embodiment in which the three-dimensional contour varies in only one direction (FIG. 2E) and an embodiment in which the three-dimensional contour varies in two directions (FIG. 2F). In FIG. 2E, the engaging projections 138 are shown as long rectangular blocks extending along the length of the engaging member 122. In FIG. 2F, the engaging projections 138 are shown as square blocks alternating in a checkerboard pattern along the length and width of the engaging member 122. Additionally, these two embodiments are appropriate for the receiving member 124 and the various other geometric cross-sectional shapes shown in FIG. 2D and discussed above.

The NT3 adhesive system has an advantage over conventional, substantially planar adhesive systems in that it is less susceptible to contaminants that can substantially reduce the adhesive strength of the NT adherent/adherend systems described herein. Typical sources of contamination include: human hands/fingers (e.g., a source of proteins, oils, surfactants, water, skin care products, polydimethylsiloxane, etc.), other conventional adhesives (e.g., hot melt adhesives and pressure-sensitive adhesives), and the environment (e.g., dirt, dust, other airborne particulates, etc.). The three-dimensional contours of the NT3 adhesive system protect its adhesive surfaces when the adhesive surfaces come into contact with a contaminating surface because the contaminants are not easily able to navigate the various crevices and recessions on the adhesive surfaces.

For instance, when human fingers grasp a portion of the engaging member 122 shown in FIG. 2C (such as during a fastening or defastening event), the finger may contact the NT adherent 130. In this case, the portion of the NT adherent 130 located on the outer engaging surfaces 138′ may lose its adhesive quality. However, the NT adherent 130 located on the side engaging surfaces 138″ and the engaging surface 126 retains its adhesive quality because the fingers have not directly contacted these surfaces and, therefore, deposited contaminants can be inhibited from entering the engaging recessions 142. This effect can be significant when the NT3 adhesive system is intended to be used for several refastening events over its lifespan.

### Physical Properties of the Adhesive System

It is desirable that the non-tacky (NT) adhesive system not lock-up after aging. Lock-up occurs when the NT adherent and the NT adherend adhere to one another with such tenacity that, upon attempted separation of the engaging member from the receiving member, the force of separation results in destruction of the NT adhesive system before the NT adherent and NT adherend separate. Destruction of the NT adhesive system entails any event that prohibits refastening of the engaging member to the receiving member by way of an interface of the NT adherent and the NT adherend. For example, destruction may occur if the NT adherent delaminates from the engaging member before the NT adherent and NT adherend separate. By way of further example, destruction may occur if the engaging member or receiving member tears before the NT adherent and NT adherend separate (i.e., force of separation exceeds tensile strength of the member). Furthermore, even if lock-up of the NT adhesive system does not occur, it is desirable that the force required to separate the NT adherent and the NT adherend is not excessive. Because the fastening system will typically be operated by hand, it is desirable that requisite separation force be targeted to the forces that may be reasonably applied by hand.

Aging of the NT adhesive system may exacerbate both lock-up and the force required to separate the NT adhesive system. Aging may involve prolonged time and elevated temperature and/or pressure, all of which tend to promote lock-up. The NT adhesive system may remain engaged for several days, weeks, or months before separation occurs. For example, the NT adhesive system may be engaged during manufacture. At some later point in time, such as after transport and storage, the NT adhesive system may need to be separated. Ideally, no lock-up will be experienced. A reasonable force may be required to separate the engaging member by peeling it from the receiving member where peel is achieved by separation of the engaging member and receiving member by application of a force in generally the z-direction. Generally, the NT adhesive system should be separable in generally the z-direction with application of less than about 4.7 N/cm (12.0 N/inch) of force, for example less than about 3.9 N/cm (10.0 N/inch) or, alternatively, less than about 3.1 N/cm (8.0 N/inch). Above 4.7 N/cm, some consumers may find it difficult to unfasten the system. In certain embodiments, separation should occur with between about 0.4 N/cm (1.0 N/inch) to about 3.9 N/cm (10 N/inch) of force. In certain embodiments, separation should occur with between about 0.8 N/cm (2.0 N/inch) to about 3.1 N/cm (8.0 N/inch) of force. In certain embodiments, separation should occur with about 2.0 N/cm (5.0 N/inch) of force. All recited separation forces are measured according to the T-Peel Test as described in the Test Methods section below. While a lower limit is not necessarily required, it may be desirable to have a lower limit on separation force value, for example at least about 0.4 N/cm (1.0 N/inch) or, alternatively, at least about 0.8 N/cm (2.0 N/inch). Otherwise, the NT adhesive system may experience an untimely, spontaneous separation (i.e., the NT adhesive system may unintentionally separate due to some force experienced during transport, storage, use, or handling).

These desirable values for the peel force in the NT adhesive system are achieved by selecting a NT adherent/NT adherend combination based on the corresponding peel force when the combination is applied uniformly to planar test surfaces and analyzed according to the T-Peel test. Because the reduced relative adhesive surface contact area in a NTP adhesive system attenuates the resulting peel force, a NT adherent/NT adherend combination having a peel force of less than about 8.7 N/cm (21.8 N/in) is preferred, for example less than about 7.0 N/cm (17.5 N/inch). Because the relative adhesive surface contact area in a NT3 adhesive system is not generally reduced (i.e., the three-dimensional surfaces are uniformly coated with NT adherent and NT adherend), the typical value of less than about 4.7 N/cm (12.0 N/inch) is preferred, for example less than about 3.9 N/cm (10.0 N/inch). When the intermeshing structure of the NT3 system provided additional mechanical adhesion forces (e.g., when the engaging and receiving projections are mushroom-shaped), it is preferable to select a NT adherent/NT adherend combination with a lower T-Peel value such that the net T-Peel value of the NT3 adhesive system itself less than about 4.7 N/cm (12.0 N/inch). NT adherent/NT adherend pairs having suitable peel forces when applied uniformly to planar test surfaces are provided in the Examples section (in Table 1) below.

In suitable embodiments capable of being subjected to an accelerated aging process, the NT adhesive system may exhibit a minimal increase in T-Peel force over a prescribed period of time. Particularly, the NT adhesive system may exhibit a T-Peel force after 1 week of aging (at 60° C. and under 0.8 N/cm² pressure) of no more than 20% greater than the T-Peel force after 3 days of aging (at 60° C. and under 0.8 N/cm² pressure). In other embodiments, the aged, NT adhesive system may exhibit a T-Peel force after 1 week of aging (at 60° C. and under 0.8 N/cm² pressure) of no more than 15%; alternately, 10%; or alternately, 5% greater than the T-Peel force after 3 days of aging (at 60° C. and under 0.8 N/cm² pressure). In certain embodiments, the T-Peel force after 1 week of aging at 60° C. and under 0.8 N/cm² pressure is substantially the same as of the T-Peel force after 3 days of aging at 60° C. and under 0.8 N/cm² pressure (i.e., the difference in T-Peel force between the T-Peel after 1 week of aging and the T-Peel force after 3 days of aging is within the experimental error of either the 1-week or 3-day values).

In another aspect of the present invention, the NT adhesive system may exhibit a degree of adhesive strength upon refastening. Particularly for use in disposable absorbent articles, it is preferable that a fastening system maintains its adhesive integrity after three refastening events (i.e., a fastening system is engaged and separated three times).

It is desirable that the NT adhesive system exhibit suitable shear strength. Shear loads are generally applied along the x-axis. Two shear values may be considered: peak shear load (i.e., dynamic shear) or sustained load over time (i.e., static shear). With regard to integrity against a static, sustained load, the NT adhesive system may exhibit a shear hang time of about 50 minutes or more. Alternately, the NT adhesive system may exhibit a Shear Hang Time of about 120 minutes or more or about 240 minutes or more. Clearly, it is most desirable that the NT adhesive system exhibit a perpetual shear hang time. These values are obtained by selecting a NT adherent/NT adherend combination based on the corresponding shear hang time (i.e., about 50 minutes or more, preferably about 120 minutes or more, or most preferably about 240 minutes or more) when the combination is applied uniformly to planar test surfaces and analyzed according to the Shear Hang Time Test. The shear hang time is measured according to the Shear Hang Time Test as described in the Test Methods section below.

With regard to integrity against a dynamic load, the NT adhesive system may exhibit a dynamic shear of at least about 3.1 N/cm² (20 N/inch²). In certain embodiments, the NT adhesive system may exhibit a dynamic shear of at least about 4.7 N/cm² (30 N/inch²). In other suitable embodiments, the NT adhesive system may exhibit a dynamic shear of at least about 6.2 N/cm² (40 N/inch²) or of at least about 9.3 N/cm² (60 N/inch²). These values are obtained by selecting a NT adherent/NT adherend combination based on the corresponding shear hang time (i.e., at least about 3.1 N/cm², preferably at least about 4.7 N/cm², most preferably at least about 6.2 N/cm², for example at least about 9.3 N/cm²) when the combination is applied uniformly to planar test surfaces and analyzed according to the Dynamic Shear Test test. Dynamic shear is measured according to the Dynamic Shear Test as described in the Test Methods section below.

In another aspect of the present invention, the aged NT adhesive system in a refastened configuration should not exhibit lock-up nor require excessive force for subsequent separation of the NT adhesive system. In certain embodiments, the aged NT adhesive system after three refastening events (i.e., three separation and engaging events after aging) should not exhibit lock-up nor require excessive force for subsequent separation of the NT adhesive system. The principles underlying lock-up of the NT adhesive system and the force required to separate the NT adhesive system in its refastened configuration are substantially the same as those presented above with respect to lock-up and force of separation with regard to the NT adhesive system in its initial aged pre-engaged state. Generally, the NT adhesive system in its refastened state should be separable with application of less than about 4.7 N/cm (12 N/inch) of force, for example less than about 3.9 N/cm (10.0 N/inch) or, alternatively, less than about 3.1 N/cm (8.0 N/inch). Optionally, the separation force value should be at least about 0.4 N/cm (1.0 N/inch) or, alternatively, at least about 0.8 N/cm (2.0 N/inch). In certain embodiments, separation should occur with between about 0.4 N/cm (1.0 N/inch) to about 3.9 N/cm (10 N/inch) of force. In certain desirable embodiments, separation should occur with between about 0.8 N/cm (2.0 N/inch) to about 3.1 N/cm (8.0 N/inch) of force. These separation forces are measured according to the T-Peel Test as described in the Test Methods section below after three refastening events. Furthermore, the refastened NT adhesive system may exhibit the shear hang time and dynamic shear values as recited above.

These desirable values for the peel force in the refastened NT adhesive system are achieved by selecting a NT adherent/NT adherend combination based on the same criteria described above with respect to the non-refastened NT adhesive system.

The NT adhesive system or a refastened NT adhesive system may exhibit any combination of the above cited characteristics including T-Peel force, shear hang time, and/or dynamic shear force.

### Fabrication of the Adhesive System

Generally, the engaging member and the receiving member may be any two items that can be joined together or that are desired to be joined together by way of the non-tacky adhesive system. The engaging member and/or the receiving member may be constructed from any number of suitable substrates or materials. The engaging member and receiving member may be a sheet material wherein the dimensions on the largest planar face exceed, often by many orders of magnitude, the caliper or thickness of the sheet. Such sheet material may be polymeric films, metallic films, nonwoven materials, woven materials, paper, cardboard, paperboard, and combinations thereof (e.g., composites and laminates). However, the engaging member and/or the receiving member may be constructed from any material that is commonly used in traditional adhesive or mechanical fastening systems. In certain embodiments, the engaging member and/or receiving member may be constructed from a material with sufficient tensile strength that it can be processed and handled at commercially feasible speeds. In certain embodiments, the engaging member may be constructed from the same material as the NT adherent. In certain embodiments, the receiving member may be constructed from the same material as the NT adherend. In certain embodiments, the NT adhesive system may be pre-engaged.

A variety of materials are suitable for use in the present invention as the NT adherent and/or as the NT adherend. In general, the NT adherent and the NT adherend can be the same or different material. In embodiments having more than one NT adherent, the NT adherent disposed on the engaging surface at a given location can be the same or different material relative to the NT adherent at other locations. Similarly, in embodiments having more than one NT adherend, NT adherend disposed on the receiving surface at a given location can be the same or different material relative to the NT adherend at other locations.

Suitable materials include styrenic block copolymers, polyesters, polyamides, polyisoprene, natural and synthetic rubber, olefinic homopolymers, latex, and acrylonitrile copolymers. Oriented variants of the aforementioned list may also serve as suitable cohesive materials. Surface energy modified variants of the aforementioned list may also serve as suitable materials for the NT adherent and/or NT adherend. In certain embodiments, suitable materials include styrene conjugated diene copolymers (including polystyrene-polybutadiene-polystyrene (SBS) triblock copolymers and polystyrene-polyisoprene-polystyrene (SIS) triblock copolymers), poly(ethylene terephthalate) (PET) and surface energy modified variants, oriented polyamides and surface energy modified variants, and polyolefins (including polypropylene and polyethylene) and surface energy modified variants. Surface energy modification may occur by chemical or high-energy treatments. Suitable surface high-energy modification techniques include but are not limited to corona discharge treatment, plasma treatment, UV radiation treatment, ion beam treatment, electron beam treatment, and certain laser treatments including pulsed lasers. Suitable chemical surface energy modification techniques include, but are not limited to, the use of hydrophobic surface treatments and hydrophilic surface treatments. Other suitable materials for the NT adherent and/or NT adherend include webs of materials which are both elastic and provide cohesive properties as described in U.S. Pat. No. 6,156,424. In certain embodiments, suitable NT adherent and NT adherend combinations include SBS or SIS block copolymers/PET, SBS or SIS block copolymers/oriented polyamides, SBS or SIS block copolymers/surface modified oriented polyamides, SBS or SIS block copolymers/polyolefins, SBS or SIS block copolymers/oriented polyolefins, SBS or SIS block copolymers/surface modified polyolefins, and SBS or SIS block copolymers/SBS or SIS block copolymers.

The NT adherent may be affixed to the engaging surface of the engaging member by any bonding means known in the art including, but not limited to, pressure bonds, thermal bonds, adhesive bonds, or ultrasonic bonds. In some embodiments, the NT adherent may be extruded onto the engaging member or the engaging member may be extruded onto the NT adherent. The NT adherent may be in a molten or fluid state such that, upon solidification, the material is physically locked into the engaging surface. In other suitable embodiments, a hot melt adhesive may be used to affix the NT adherent to the engaging member. The NT adherend may be affixed to the receiving surface of the receiving member by any bonding means as presented above in regard to the NT adherent.

The patterns and three-dimensional contours of the disclosed adhesive systems can be formed by a variety of conventional techniques. Techniques such as spraying (e.g., in bead form, in spiral form) and printing (e.g., gravure, flexo, intaglio) can be used to apply an NT adherent/adherend to an engaging/receiving surface having any arbitrary two-dimensional pattern when used in a NTP adhesive system. Similarly, solvent coating and casting techniques can be used to form the pattern in a NTP adhesive system. Stamping, forging, and forming techniques are appropriate for creating the three-dimensional surfaces in a NT3 adhesive system. In these cases, an entire structure (e.g., the engaging member 122, the engaging projections 138, and the NT adherent 130) can be formed from a single NT adherent, thereby eliminating the need to separately apply a NT adherent to an underlying three-dimensional substrate. Similarly, the receiving member 124, the receiving projections 140, and the NT adherend 132 can be formed from a single NT adherend. Techniques such as slot coating and extrusion coating can be used to form NTP and NT3 adhesive systems whose structure varies in only one direction (e.g., the engaging member 22 shown in FIG. 1C for a NTP adhesive system and the engaging member 122 shown in FIG. 2E for a NT3 adhesive system). For example, either method can be used to apply a thin NT adherent/adherend layer on a non-tacky substrate to create the substantially two-dimensional patterned surface of a NTP adhesive system. Either method also can be used to apply a NT adherent/adherend layer of non-uniform thickness across a substrate cross-section, thereby forming the three-dimensional surface of a NT3 adhesive system.

### Application—Two-Component Tape

A NT adhesive system having any of the above described characteristics may be a component of a consumer good. For example, traditional two-sided tape (e.g., a substrate with a traditional adhesive on both planar faces) is often used for a variety of purposes in residential and commercial settings. Two-sided tape may be used, for example, to attach carpet to a floor, to attach polymer film to a window opening, or to attach pictures to a wall. Two-sided tapes allow one surface of the tape to be attached to a first material (e.g., carpet) and the other surface of the tape to be attached to a second material (e.g., a floor), whereby the first and second materials are joined. However, two-sided tapes often do not provide suitable adhesion if the first and second materials are separated and refastened.

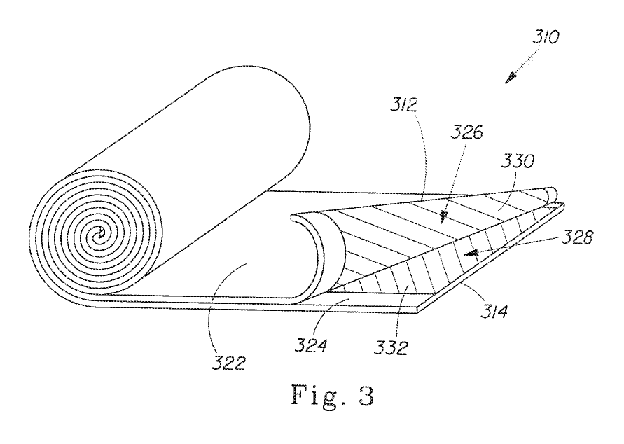

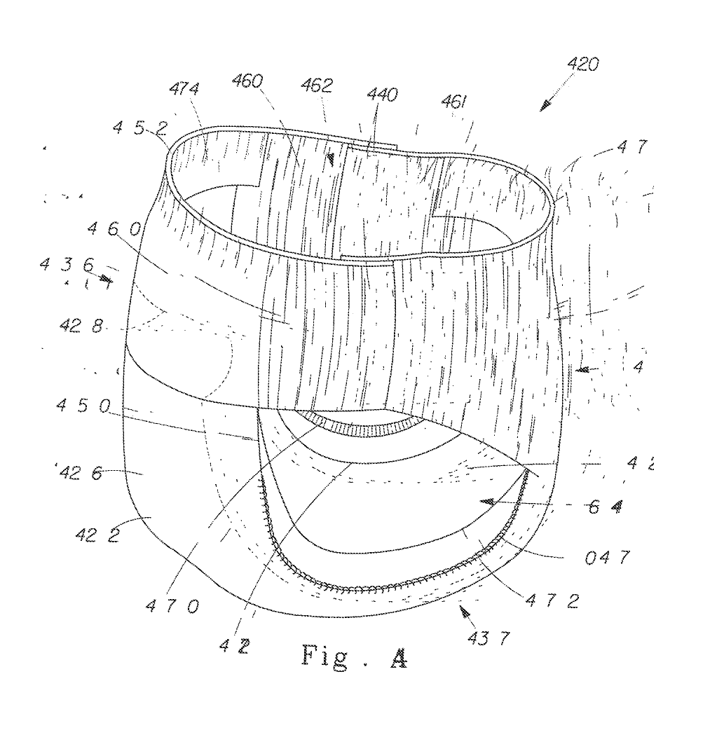

FIG. 3 is a perspective view of a two-component tape 310 shown as a rollstock that includes a NT adhesive system and may be used as a replacement for conventional two-sided tape. The two-component tape 310 includes a first tape 312 and a second tape 314. The first tape 312 includes an engaging member 322 and the second tape 314 includes a receiving member 324. The engaging member 322 and the receiving member 324 are analogous to the like-named components of the NTP adhesive system and the NT3 adhesive system. The engaging member 322 and the receiving member 324 may further include structure consistent with the NTP and NT3 adhesive systems discussed above, for example a patterned, three-dimensional, or uniform engaging surface 326 having a NT adherent 330 and a complementary receiving surface 328 having a NT adherend. The two-component tape 310 may be provided in a variety of forms such as a sheet, a ribbon, or any two-dimensional shape such as a circle, square, heart, or the like. Discrete pieces of the two-component tape 310 may be packaged for transport, handling, and/or sale. A continuous piece of the two-component tape 310 may be folded, rolled, pleated, and the like for transport, handling, and/or sale. The two-component tape 310 may be used in a variety of household or commercial situations. For example, two-component tape 310 may be used in production of further consumer foods or packaging, such as the articles and overwraps described herein.

In an alternate embodiment (not shown), the two component tape 310 using the NT adhesive system includes additional conventional adhesive elements. In this embodiment, the exterior surfaces of the engaging member 322 and the receiving member 324 (i.e., those surfaces that do not engage in the NT adhesive system), are coated with a conventional adhesive, which is protected with release paper until use. The conventional adhesive preferably has an adhesive strength greater than that of the NT adhesive system. Ideally, the two-component tape 310 should separate at the interface of the NT adhesive system, and not at the interface between the conventional adhesive and its attached surface (e.g., carpet). Suitable conventional adhesives include traditional adhesives, selective adhesives, and/or cohesives. Traditional adhesives may allow for more varied uses of the two-component tape 310 because traditional adhesives generally exhibit adhesion to a broad spectrum of surfaces. The release paper may be selected based upon the particular conventional adhesive. One suitable conventional adhesive-release paper combination includes an adhesive available as double-sided tape code 6589 from 3M Company, St. Paul, Minn.

### Application—Absorbent Article

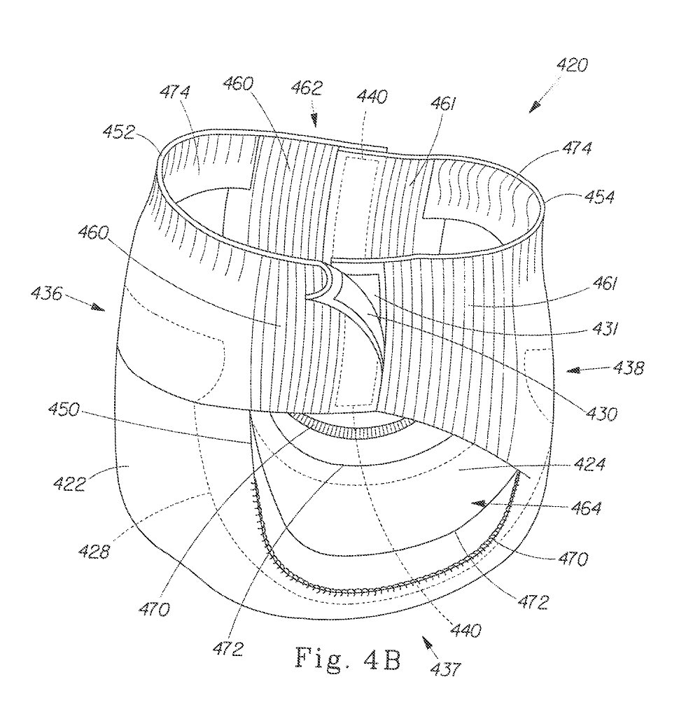

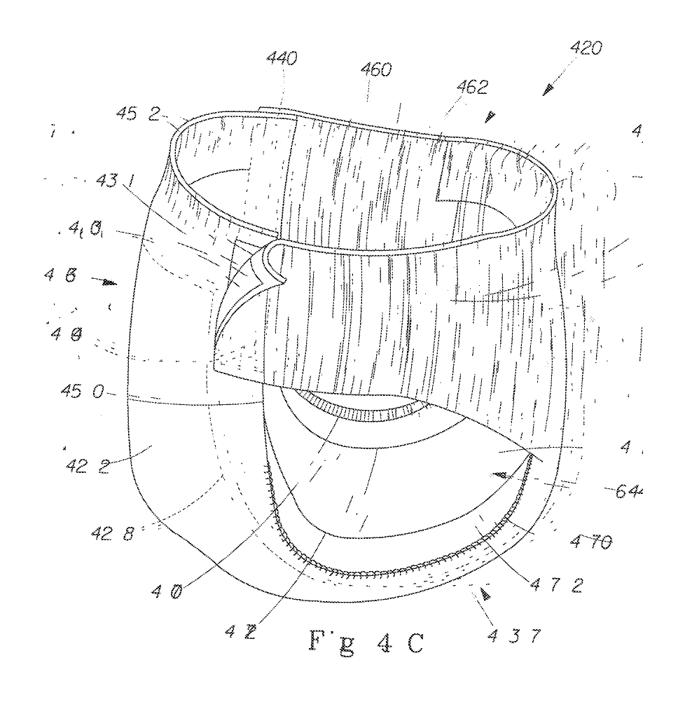

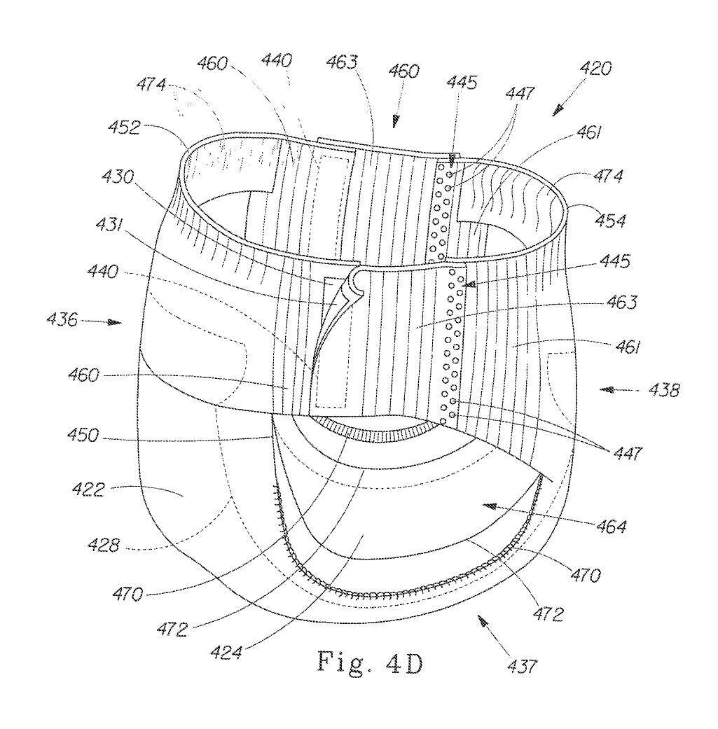

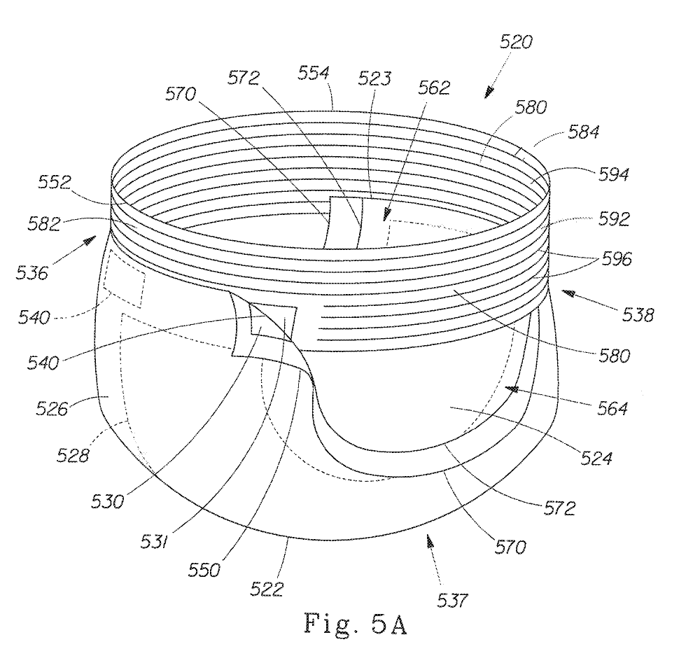

A pre-engaged non-tacky aged adhesive fastening system may be a component of other consumer goods such as absorbent articles and disposable absorbent article. While a pants-type diaper is shown in FIGS. 4A-D, the non-tacky adhesive fastener may be used in other absorbent articles such as taped diapers, adult incontinence products, feminine hygiene products, and the like. The pants-type diaper 420 of FIG. 4A may include an absorbent assembly 422, side panels 460, 461, and a NT adhesive system 440. The NT adhesive system 440 may further include structure consistent with the NTP and NT3 adhesive systems discussed above. The diaper 420 may have a front waist region 436, a back waist region 438 opposed to the front waist region 436, and a crotch region 437 located between the front waist region 436 and the back waist region 438. The periphery of the diaper 420 is defined by longitudinal edges 450 that lie generally parallel to a longitudinal centerline and the front waist edge 452 and back waist edge 454 that lie generally parallel to a lateral centerline of the diaper 420 and extend between the longitudinal edges 450.

The absorbent assembly 422 of the diaper 420 may include a liquid pervious topsheet 424, a backsheet 426, and an absorbent core 428 which may be positioned between at least a portion of the topsheet 424 and the backsheet 426. The absorbent assembly 422 may constitute the main structure of the diaper with other features added to form the composite diaper structure. The absorbent assembly 422 and generally all elements of diaper 420 may have a body-facing surface which generally is in contact with the body or in close proximity to the body when the article is worn. The absorbent assembly 422 may have a garment-facing surface opposed to the body-facing surface and which generally contacts with or may be in close proximity to any garment being worn. The topsheet 424, the backsheet 426, and the absorbent core 428 may be assembled in a variety of configurations well known in the art. Representative absorbent assembly structures are described in U.S. Pat. Nos. 5,899,895 and 6,120,487.

The backsheet 426 is generally that portion of the diaper 420, which is disposed adjacent the garment-facing surface of the absorbent core 428 and which prevents the excreta and/or exudates contained therein from soiling garments or other articles which may contact the diaper 420, such as bedsheets and clothing. In preferred embodiments, the backsheet 426 may be substantially impervious to liquid and may include any suitable thin plastic film known in the art, including a breathable film. Suitable backsheet films include those manufactured by Tredegar Industries, Inc., Terre Haute, Ind., USA, and sold under the trade names X15306, X10962, and X10964.

The backsheet 426 may be joined to the topsheet 424, the absorbent core 428 or any other element of the diaper 420 or absorbent assembly 422 by any attachment means known in the art. For example, the attachment means may include a uniform continuous layer of adhesive, a patterned layer of adhesive, or an array of separate lines, spirals, or spots of adhesive. Suitable adhesives include those manufactured by H.B. Fuller Company of St. Paul, Minn., USA, and marketed as HL-1620 and HL-1358-XZP. Alternately, the attachment means may include heat bonds, pressure bonds, ultrasonic bonds, dynamic mechanical bonds, or any other suitable attachment means or combinations of attachment means known in the art.

The topsheet 424 is preferably disposed adjacent the body-facing surface of the absorbent core 428 and may be joined to the absorbent core 428 and/or to the backsheet 426 by any attachment means known in the art. The topsheet 424 is preferably compliant, soft-feeling, and non-irritating to the wearer's skin. Preferably, at least a portion of the topsheet 424 is liquid pervious, permitting liquids to readily penetrate through its thickness. A suitable topsheet may be manufactured from a wide range of materials known in the art, such as porous foams, reticulated foams, apertured plastic films, or woven or nonwoven materials of natural fibers such as wood or cotton fibers, or synthetic fibers such as polyester or polypropylene fibers, or a combination of natural and synthetic fibers. If the topsheet 424 includes fibers, the fibers may be spunbond, carded, wet-laid, meltblown, hydroentangled, or otherwise processed as is known in the art. One suitable topsheet material is a thermobonded carded web which is available as Supplier Code No. P-8 from Fiberweb North America, Inc., Simpsonville, S.C., U.S.A.

The absorbent core 428 may include any absorbent material which is generally compressible, conformable, non-irritating to the wearer's skin, and capable of absorbing and retaining liquids such as urine and other bodily exudates. The absorbent core 428 may be manufactured in a wide variety of sizes and shapes, for example, rectangular, hourglass, “T”-shaped, asymmetric, etc. The absorbent core 428 may include any of a wide variety of liquid-absorbent materials commonly used in disposable diapers and other absorbent articles, such as comminuted wood pulp, which is generally referred to as airfelt, cellulose wadding, meltblown polymers, chemically stiffened, modified, or cross-linked cellulosic fibers, tissue, absorbent foams including those prepared from polymerization of a high internal phase emulsion, superabsorbent polymers, absorbent gelling materials, or any other known absorbent material or combinations of materials. Suitable absorbent core structures are described in U.S. Pat. Nos. 4,610,678 and 5,260,345.

The diaper 420 may include a variety of other structures. The diaper 420 may include at least one leg cuff. Leg cuffs are known variously in the art as gasketing cuffs, containment flaps, “stand-up” elasticized flaps, barrier cuffs, leg bands, side flaps, and/or elastic cuffs. As shown in FIGS. 4A-D, the diaper includes a pair of gasketing leg cuffs 470 and a pair of barrier leg cuffs 472. Leg cuffs 470, 472 may be constructed in any suitable configuration known in the art, including those described in U.S. Pat. No. 4,695,278 and U.S. Pat. No. 4,795,454.

The diaper 420 may also include a waist feature 474. The waist feature 474 may be disposed along the front waist edge 452 and/or the back waist edge 454 of the diaper 420; generally the waist feature 474 will form a portion of the front waist edge 452 and/or the back waist edge 454. The waist feature 474 may be at least laterally elastically extensible to provide circumferential tension at the diaper waist opening 462. The waist feature 474 may be constructed in any of several different configurations known in the art. Exemplary waist feature constructions include those described in U.S. Pat. No. 4,515,595 and U.S. Pat. No. 5,221,274. The diaper 420 may also include side panels 460, 461 disposed in the front waist region 436 and the back waist region 438, respectively.

The diaper 420 may have a pair of front side panels 460 disposed generally transversely outward from the longitudinal edges of the absorbent assembly and at or near the front waist region 436. Similarly, the diaper 420 may have a pair of rear side panels 461 disposed generally transversely outward from the longitudinal edges of the absorbent assembly and at or near the rear waist region 438. The respective waist regions 436, 438 together with the side panels 460, 461 may form a continuous waist opening 462 and leg openings 464 when the side panels 460, 461 are joined by the NT adhesive system 440.

The side panels 460, 461 may be constructed in any suitable configuration known in the art. The side panels 460, 461 may be elastically extensible. The side panels 460, 461 may be made extensible or elastic by any of a variety of techniques known in the art. For example, an elastic side panel 460, 461 can be made by disposing an elastic member, such as elastic strands or films, between facing layers of cover material, such as a non-woven material. A suitable elastic side panel is described in U.S. Pat. No. 5,669,897. The side panels 460, 461 may be integral with the absorbent assembly 422 (i.e., they may be continuous extensions of one or more of the layers of the absorbent assembly 422) or they may be separately attached to the absorbent assembly 422. Alternately, the side panels 460, 461 may be made of multiple components or layers some of which are discrete (i.e., either attached separately to the absorbent portion or separated therefrom by a gap) and some of which are continuous. An example of this type of construction is a diaper provided with an outer nonwoven cover which completely covers all areas of the diaper 420 including the side panels 460, 461 and the absorbent assembly 422.

The diaper 420 also includes a NT adhesive system 440. The NT adhesive system 440 preferably maintains the front waist region 436 and the back waist region 438 in a continuous encircling configuration during wear. As shown in FIG. 4A-B, the NT adhesive system 440 may be disposed in proximity to the distal edge of the side panels 460, 461 where the side panels 460, 461 overlap, meet, or abut. The NT adhesive system 440 may include a NT adherent 430 disposed on the front side panel 460. The NT adherent 430 is shown in FIG. 4B as being disposed on the body-facing surface of the front side panel 460. The NT adhesive system 440 may include a NT adherend 431 disposed on the rear side panel 461. The NT adherend 431 is shown in FIG. 4B as being disposed on the garment-facing surface of the rear side panel 461. As should be appreciated, the NT adherent 430 and the NT adherend 431 may be disposed on any combination of the body-facing surface and/or the garment-facing surface of the front side panels 460 and/or the body-facing surface and/or the garment-facing surface of the rear side panels 461. During manufacture of the diaper 420, the NT adherent 430 and the NT adherend 431 may be joined so as to form a closed, pant-type diaper where the waist opening 462 and leg openings 464 are formed. FIG. 4B shows the diaper 420 of FIG. 4A with the NT adhesive system 440 partially separated.

In one aspect of the present invention, the NT adhesive system 440 may exhibit sufficient adhesive strength to maintain the diaper 420 in a closed configuration during transport, storage, and wear. The NT adhesive system 440 may exhibit refastenability. In certain embodiments, the NT adhesive system 440 may be separated and re-attached at least three times. Refastening of the diaper 420 is common during the application, wear, and removal. For example, the NT adhesive system 440 provides flexibility of application. The caregiver can apply the diaper 420 in the closed, pants-type form (with the aged NT adhesive system 440 left intact and unseparated) where the wearer steps into the diaper 420. Alternately, the caregiver can apply the diaper 420 in an open form by first separating the aged NT adhesive system 440, applying the diaper 420 to the child (e.g., child is often lying supine), and refastening the NT adhesive system 440. The NT adhesive system 440 can be fastened before the diaper 420 is pulled up the wearer's legs or can be fastened after the diaper 420 is positioned ready for use on the wearer. In some cases, after application of the diaper 420 (i.e., wearer steps into the leg opening and pulls the diaper 420 up and over his or her hips), the NT adhesive system 440 may be separated and re-attached to provide a more customized fit. During wear, the NT adhesive system 440 may be separated to allow inspection of soiling of the diaper 420. If the diaper 420 has not been soiled, the NT adhesive system 440 may be re-attached and diaper 420 may continue to be worn.

The components of the NT adhesive system 440 may be disposed on the side panels 460, 461, respectively, in a variety of methods well known in the art. The NT adhesive system 440 may be pre-formed as discrete elements (e.g., an engaging member and a receiving member along with any additional structure disposed thereon) that are joined to the diaper 420 by a bonding method such as, for example, adhesive, pressure, or heat bonds. The NT adhesive system 440 may be formed on the diaper 420 during the manufacturing process of the diaper 420. For example, the NT adherent 430 and/or the NT adherend 431 may be deposited onto the diaper 420 by hot melt application, extrusion, printing, or other like methods. In certain embodiments, the NT adherent 430 and/or the NT adherend 431 may be applied in a molten form by a conventional slot coater. The NT adherent 430 and the NT adherend 431 may be disposed on the diaper 420 by the same or different methods.

FIGS. 4A-B show the NT adhesive system 440 positioned at approximately the midpoint between the front waist region 436 and back waist region 438 along the side panels 460, 461. However, in other embodiments, the NT adhesive system 440 may be located anywhere on the diaper 420 so that the diaper 420 is presented in a closed state (i.e., continuous waist opening and leg opening formed during manufacture). FIG. 4C illustrates one embodiment of the diaper 420 where a single side panel 460 may extend between and interconnect the front waist region 436 to the rear waist region 438. The side panel 460 may be joined to and extend laterally from the longitudinal edge 450 of the rear waist region 438 of the absorbent assembly 422. The NT adherent 430 may be disposed on the body-facing surface (as shown in FIG. 4C) or the garment-facing surface of the side panel 460. The NT adherend 431 may be disposed on the garment-facing surface (as shown in FIG. 4C) or the body-facing surface of the absorbent assembly 422. The NT adherent 430 and the NT adherend 431 may generally be positioned so that the side panel 460 may overlap and attach to the absorbent assembly 422. As should be appreciated, the NT adherent 430 and the NT adherend 431 may be disposed on the absorbent assembly 422 and the side panel 460, respectively. In other embodiments, the side panel 460 may be designed to extend from the front waist region 436 so that the NT adhesive system 440 is located in rear waist region 438 of the diaper 420.

In another embodiment, the diaper 420 includes the NT adhesive system 440 and a permanent bond 445. As shown in FIG. 4D, the diaper 420 may have a pair of front side panels 460 disposed generally transversely outward from the opposing longitudinal edges 450 of the absorbent assembly 422 at or near the front waist region 436. The diaper 420 may have a pair of rear side panels 461 disposed generally transversely outward from the opposing longitudinal edges 450 of the absorbent assembly 422 and at or near the rear waist region 438. The diaper 420 may have a pair of intermediate side panels 463 each joined to or disposed between the front side panel 460 and the rear waist panel 461. The intermediate side panel 463 may be elastic, inelastic, or extensible. The front side panel 460 and the intermediate side panel 463 may be joined by the NT adhesive system 440. The NT adherent 430 is shown as being disposed on the garment-facing surface of the front side panel 460 and the NT adherend 431 is shown as being disposed on the body-facing surface of the intermediate side panel 463. As should be appreciated, the NT adherent 430 and NT adherend 431 alternately may be disposed on the intermediate side panel 463 and front side panel 460, respectively. Furthermore, the NT adherent and NT adherend 430, 431 may be disposed on the body-facing surface and/or the garment-facing surface of the side panels 460, 463.

The intermediate side panel 463 may be permanently bonded to the rear side panel 461 by a permanent bond 445. The permanent bond 445 may be created by a variety of conventional bonding techniques including pressure, thermal, adhesive, or ultrasonic bonding. The permanent bond 445 is shown as including a plurality of pressure bonds 447. During manufacture of the diaper 420 of FIG. 4D, the NT adherent 430 and the NT adherend 431 may be joined. It is believed that the use of a front, intermediate, and rear side panel 460, 463, 461, respectively, having a NT adhesive system 440 and a permanent bond 445 may be integrated in a high speed manufacturing line more easily than a single or double panel side panel. As should be appreciated, a NT adhesive system 440 may join both the front side panel 460 to the intermediate side panel 463 and/or the rear side panel 461 to the intermediate side panel 463. Furthermore, the NT adhesive system 440 may join the rear side panel 461 to the intermediate side panel 463 and the front side panel 460 and the intermediate side panel 463 may be joined by the permanent bonds 445.

In other suitable embodiments, the diaper 420 may further include a secondary fastening system in addition to the NT adhesive system 440. The secondary fastening system may be an additional NT adhesive system, a mechanical fastening system, or a traditional adhesive fastening system. Suitable secondary fastening systems include, but are not limited to, tape tabs, hook and loop fastening components, hook and hook fastening components, interlocking fasteners such as tabs & slots, buckles, buttons, snaps, and/or hermaphroditic fastening components, and any other known fastening means. Some suitable surface fastening systems are disclosed in U.S. Pat. Nos. 3,848,594; 4,662,875; 4,846,815; 4,894,060; 4,946,527; 5,151,092; 5,221,274; and 6,432,098. Secondary fastening systems may include a first member such as an adhesive tape, a hook bearing tape, or a male fastening member (e.g., tab, button, etc.) and a second member such as a landing zone for receipt of the adhesive tape, a loop bearing surface, a hook bearing surface, or a female fastening member (e.g., a slot, button hole, etc.).

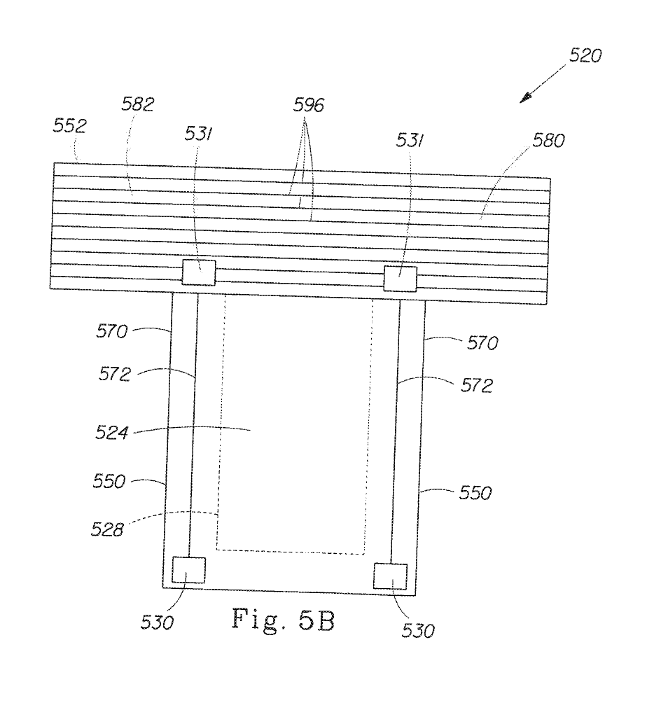

FIGS. 5A-B illustrate another embodiment of the present invention with a diaper 520 having a continuous waistband 580 and an absorbent assembly 522 refastenably attached to the waistband 580 by use of a NT adhesive system 540. The NT adhesive system 540 may further include structure consistent with the NTP and NT3 adhesive systems discussed above. FIG. 5A is a perspective view of the diaper 520 with the NT adhesive system 540 partially separated. FIG. 5B is a plan view of the front of the diaper 520 with the NT adhesive system 540 fully separated. Unless otherwise noted, elements of diaper 520 may have a similar construction or composition as the like elements as described with reference to the diaper 420 in FIGS. 4A-D. The diaper 520 has a front waist region 536, a back waist region 538 opposed to the front waist region 536, and a crotch region 537 located between the front waist region 536 and the back waist region 538. The periphery of the diaper 520 is defined by the outer edges of the diaper 520 in which side edges 550 lie generally parallel to a longitudinal centerline and the front waist edge 552 and back waist edge 554 lie generally parallel to a lateral centerline of the diaper 520 and extend between the side edges 550.

The absorbent assembly 522 of the diaper 520 may include a liquid pervious topsheet 524, a liquid impervious backsheet 526, and an absorbent core 528, which may be positioned between at least a portion of the topsheet 524 and the backsheet 526. The topsheet 524, the backsheet 526, and the absorbent core 528 may be assembled in a variety of configurations well known in the art including those as described with regard to FIGS. 4A-D. The diaper 520 may have a gasketing cuff 570 and barrier cuff 572.

The waistband 580 encircles the waist of a wearer while the diaper is worn. The waistband 580 forms a waist opening 562. The waistband may be constructed to stretch so as to accommodate a wide size range of wearers and to provide elastic resistance to the dynamic forces encountered during wear of the diaper 520. In one embodiment, the waistband 580 may be an elastic laminate. Construction of elastic laminates is well known in the art.

In one embodiment, the waistband 580 may have an outer layer 592 and an inner layer 594. An elastic member 596 may be interposed between the outer layer 592 and the inner layer 594 to provide elasticity to the waistband 580. The waistband 580 may include a variety of suitable materials. Suitable material for the waistband 580 includes a wide range of substrates such as plastic films; apertured plastic films; woven or nonwoven webs of natural materials (e.g., wood or cotton fibers), synthetic fibers (e.g., polyolefins, polyamides, polyester, polyethylene, or polypropylene fibers), or a combination of natural and/or synthetic fibers; or coated woven or nonwoven webs. The waistband 580 may include a stretchable nonwoven. In a suitable embodiment, the waistband 580 has an inner layer 594 including a hydrophobic, non-stretchable nonwoven material, an outer layer 592 including a hydrophobic, non-stretchable nonwoven material, and an elastic member 596 there between. In other embodiments, the waistband 580 may include the inner layer 594 and/or the outer layer 592 without an elastic member 596 if sufficient elasticity is present in the material which forms the inner layer 594 and/or outer layer 592 (e.g., layer may be an elastic scrim).

The elastic member 596 may include one or more elastic elements such as strands or panels extending at least in the transverse direction. The elastic member 596 may be continuously or discontinuously disposed along the transverse width of the waistband. The elastic member 596 may be disposed evenly or disproportionately along the longitudinal length of the waistband 580. The elastic member 596 may be in the form of strands continuously spanning the width of the waistband 580 and may be substantially evenly spaced along the longitudinal length. It may be desirable that no elastic member 596 be provided in the portion of the waistband 580 which overlaps with the absorbent assembly 522; in such cases the elastic member 596 may transversely span those portions of the waistband 580 that do not overlap the absorbent assembly 522.

As shown in FIGS. 5A-B, the waistband may include two portions, a front waistband region 582 and a rear waistband region 584. The absorbent assembly 522 may have a lateral rear waist edge 523. The rear waist edge 523 may overlap and may be joined to the rear waistband region 584. In this embodiment, the rear waistband region 584 and the absorbent assembly 522 are permanently joined such that absorbent assembly 522 will remain affixed to the rear waistband region 584 during the normal life of the diaper.

A NT adhesive system 540, as disclosed above, may be provided to join the absorbent assembly to the front waistband. The NT adhesive system 540 may include a NT adherent 530 disposed on the garment-facing surface of the front waistband region 582. The fastening system 540 may include a NT adherend 531 disposed on the wearer-facing surface of the absorbent assembly 522. The NT adherent and NT adherend 530, 531 may be positioned in one or more locations on the waistband 580 and absorbent assembly 522. Ideally, when the materials 530, 531 are engaged, the waistband 580 and absorbent assembly 522 form a pair of leg openings 564. As should be appreciated, the NT adherent 530 and NT adherend 531 alternately may be disposed on the absorbent assembly 522 and front waistband region 582, respectively. Furthermore, the NT adherent and NT adherend 530, 531 may be disposed on the body-facing surface and/or the garment-facing surface of the absorbent assembly 422 or the waistband 480.

### Application—Article of Commerce

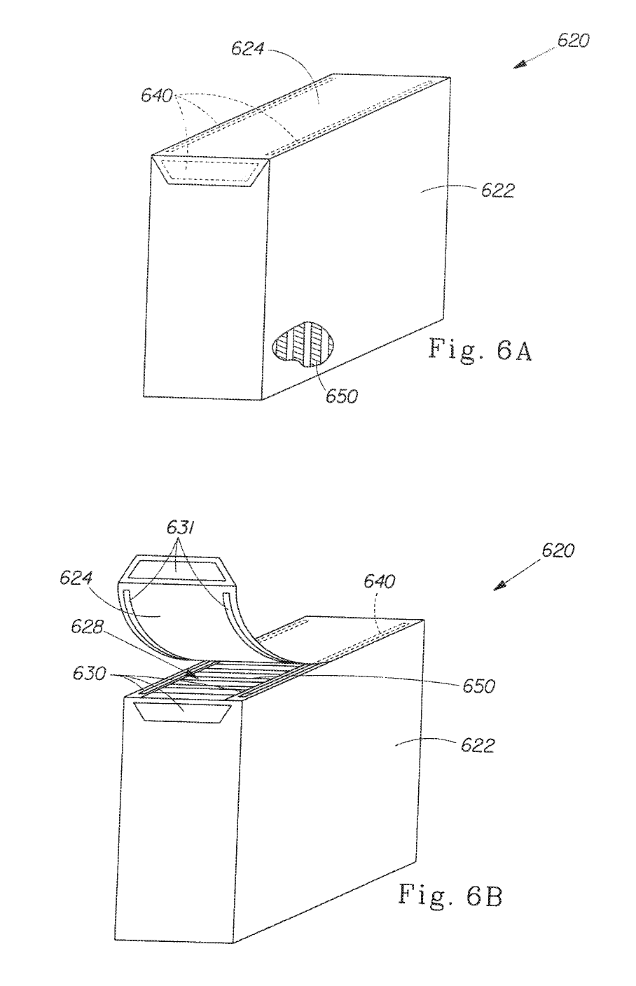

In another embodiment of the present invention as shown in FIGS. 6A and 6B, the NT adhesive system as described above may be included in an article of commerce 620 including a bag or overwrap 622 and one or more consumer or commercial goods. A NT adhesive system 640 (which may further include structure consistent with the NTP and NT3 adhesive systems discussed above) may be provided to seal the bag or overwrap 622 during manufacture. Ideally, the NT adhesive system 640 may keep the bag or overwrap 622 in a closed configuration until opened by a consumer or other end-user. In one suitable embodiment, the article of commerce 620 includes an overwrap 622, which is sealed by the NT adhesive system 640, containing a plurality of consumer goods, such as diapers 650 (which may or may not be the diapers as described above). Overwraps 622 are well-known in the art and provide the benefit of allowing a plurality of diapers 650 to be bound to one another to simplify delivery and handling. Generally, the overwrap 622 will encase the plurality of diapers 650 to prevent contamination; however, a partial overwrap 622 may be employed where one or more diapers 650 may be exposed. In the embodiments shown in FIGS. 6A and 6B, the plurality of diapers 650 may be bound together and covered by a thermoplastic film overwrap 622, such as disclosed in U.S. Pat. No. 5,934,470. Other overwraps 622 are clearly envisioned. For example, the overwrap 622 may include a variety of materials including, but not limited to, thermoplastic films, nonwovens, wovens, foils, fabrics, papers, cardboard, elastics, cords, straps, and combinations thereof. Other suitable packages and methods for packaging are disclosed in U.S. Pat. Nos. 5,050,742 and 5,054,619. Furthermore, the article of commerce 620 may contain multiple overwraps. For example, a plurality of diapers 650 may be packaged with a thermoplastic film overwrap and then a plurality of film wrapped diaper may then be overwrapped in a cardboard box or a second thermoplastic film overwrap.

The overwrap 622 may include several faces forming a three dimensional void which may be filled by the plurality of diapers 650. A closure flap 624 may extend from the overwrap 622 to cover one or more faces or portions of faces of the overwrap 622. The closure flap 624 may be an extension of the overwrap that releasably covers (i.e., can cover and be manipulated to reveal) some opening 628 in the overwrap 622 that may expose the plurality of diapers 650. The closure flap 624 may be a discrete element releasably or fixedly attached to the overwrap. The closure flap 624 may be of a shape that covers one of the faces of the plurality of diapers 650. The flap 624 includes a NT adhesive system 640 with a NT adherent 630 disposed on an exterior surface of the overwrap 622 and a NT adherend 631 disposed on an interior surface (e.g., surface proximate to the diapers) of the flap 624 or vice versa. FIG. 6A shows the NT adhesive system 640 in an engaged state, and FIG. 6B shows the NT adhesive system 640 in a partially separated state. During manufacture, the flap 624 may be positioned to engage the NT adherent 630 and the NT adherend 631. The NT adhesive system 640 should maintain the flap 624 in a closed position thereby securing the plurality of diapers 650 within the overwrap 622. Ideally, the overwrap 622 will maintain this closed position until a consumer opens the overwrap 622 by separating the NT adhesive system 640. The NT adhesive system 640 may be refastenable, which enables a user to open the flap 624 to remove a quantity of diapers and then to refasten the NT adhesive system 640 to enclose the remaining diapers 650.

In the embodiment shown in FIGS. 6A and 6B, the flap 624 may be an extension of the overwrap 622 that covers an opening 628 in the overwrap 622. The flap 624 may be permanently affixed to the overwrap 622. The flap 624 may be releasably secured to the overwrap 622 by positioning the fastening system 640 in areas where the flap 624 and overwrap 622 overlap when the flap 624 covers the opening 628. FIGS. 6A-B show the overlapping area as being on opposing edges of the internal face of the flap 624 and along two bands of the overwrap 622 that define opposing sides of the opening 628.

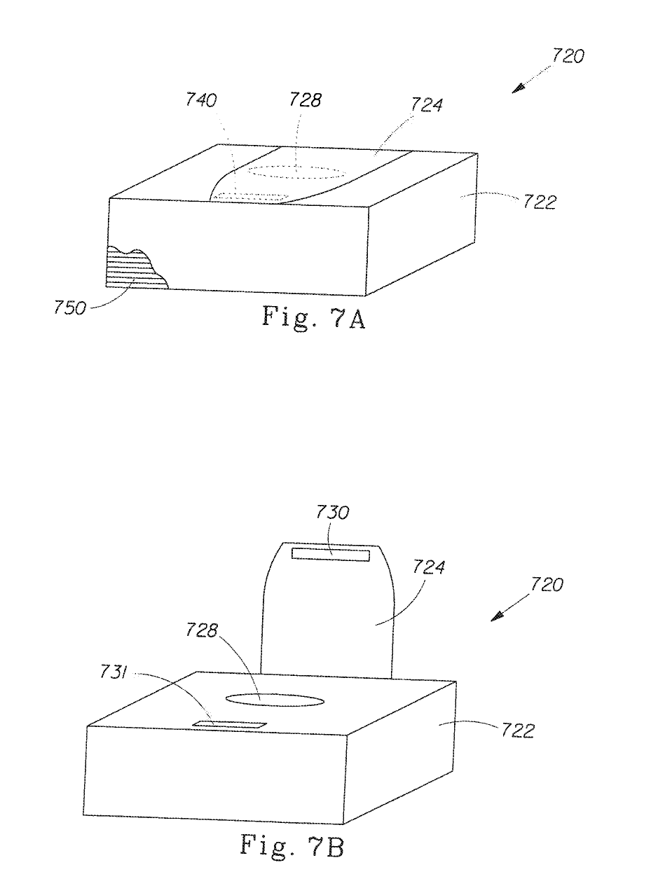

In another embodiment of an article of commerce 720 as shown in FIGS. 7A and 7B, a plurality of wipes 750 may be packaged within an overwrap 722. The overwrap 722 may be made from a moisture impervious material such as polymer films, metallic foils, and the like. Furthermore, the overwrap 722 may be a rigid plastic structure such as a tub which is commonly available. Wipes, tissues, and the like may be contained within the overwrap 722. Wipes 750 packaged within an overwrap 722 are commonly used to refill a permanent, rigid container. In certain embodiments, the overwrap 722 may include a recloseable dispensing mechanism allowing access and removal of one or more wipes 750. A flap 724 may extend from the face of the overwrap 722 and may cover an opening 728 in the overwrap 722. One flap 724 or edges of the flap 724 may be releasably affixed to the overwrap 722 by use of a NT adhesive system 740 (which may further include structures consistent with the NTP and NT3 adhesive systems discussed above). A NT adherent 730 may be disposed on the interior surface of the flap 724 and a NT adherend 731 may be disposed on the exterior surface of the overwrap 722 or vice versa. During manufacture the NT adherent 730 and the NT adherend 731 are engaged thereby securing the flap 724 to the overwrap 722 and covering the opening 728. In some embodiments, the NT adhesive system 740 may partially or fully encircle the opening 728 so a relatively moisture impervious seal is formed. In use, the flap 724 may be released from the overwrap 722 by separating the NT adherent 730 from the NT adherend 731. The wipes 750 may be accessed and removed through the opening 728. The NT adhesive system 740 may then be refastened thereby re-closing the flap 724 and protecting the remaining wipes 750 within the overwrap 722.

### Test Methods

For each of the test methods described below, the adherent and adherend must be handled with care to avoid contact with hands, skin, or other contaminating surfaces. Clean sheets of untreated paper may be used to protect the surfaces of the adherent and adherend during the sample preparation.

T-Peel Test

This method is used to determine the T-Peel strength of the bond formed between an adherent and an adherend. The adherent and adherend may be applied uniformly to planar test surfaces, or they may be incorporated into a NT adhesive system disclosed herein. The test may be performed for pre-engaged systems after an accelerated aging process, and/or after refastening the system a predetermined number of times. The sample preparation for T-peel test will vary based on whether the material is available as a discrete web or is incorporated in a product.

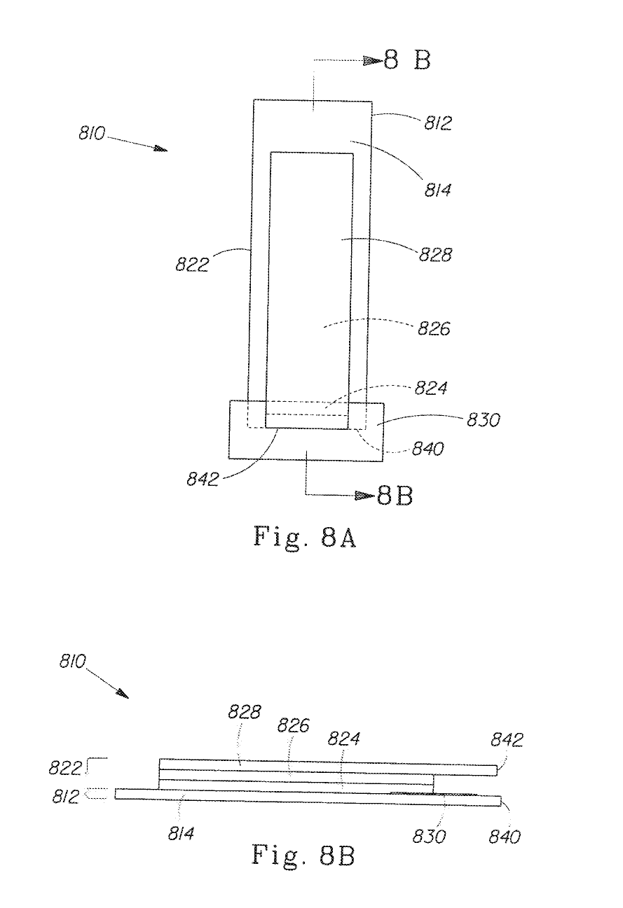

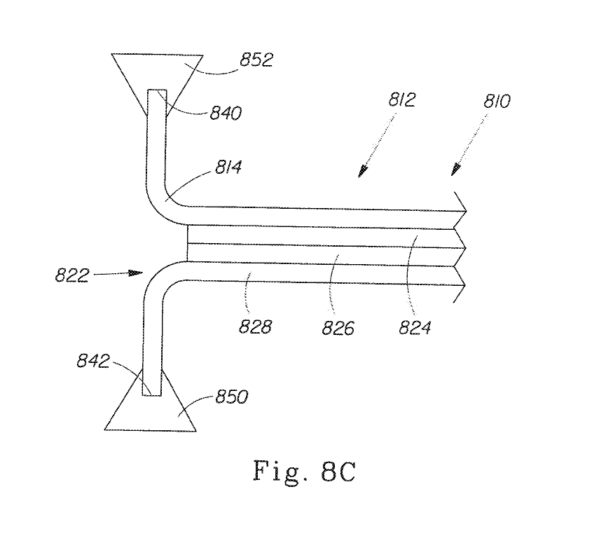

FIGS. 8A and 8B illustrate a bonded sample 810 formed according to the directions provided below when the material is a discrete web. FIG. 8B is a cross-sectional view taken along sectional line b-b of FIG. 8A.

For a receiving sample 812 having a proximal edge 840, an adherend 814 is resized using cutting dies to create rectangular receiving samples with the dimensions of about 3.5 cm (1.4 inches) wide and about 20 cm (7.9 inches) long. In instances where the adherend 814 is elastomeric, the receiving sample is backed with like sized piece of poly(ethylene terephthalate) film or paper using double sided tape.

For the engaging sample 822, a 2.54 cm (1 inch) wide×10.2 cm (4 inches) long piece of an adherent 824 is bonded in a face-to-face relationship to a similarly sized piece of double-sided tape 826 (such as FT 239 available from Avery Dennison Corp., Painesville, Ohio, or 9589 available from 3M, St. Paul, Minn.). The adherent 824 and double-sided tape 826 are joined to be substantially coterminous. The adherent 824 is to be wrinkle free. It should be appreciated that the adherent/double sided tape laminate can be created with larger sized materials and then resized to 2.54 cm×10.80 cm. The other side of the double side tape 826 is bonded onto an approximately 2.54 cm×15 cm (1 inch×5.9 inches) piece of 0.05 mm (2 mil) poly(ethylene terephthalate) (PET) film 828. The PET 828 is bonded to be coterminous with three edges of the adherent/double sided tape laminate leaving a proximal edge 842 of the PET unbonded to the adherent/double sided tape laminate. The PET film 828 is used as a backing to prevent stretching of the adherent 824 during testing.

In FIGS. 8A to 8C, the adherent 824 may represent a uniform layer applied to a planar engaging sample 822. Additionally, the adherent 824 may represent all of the engaging components of the NT adhesive systems described herein. For example, in a NTP adhesive system, the adherent 824 includes the engaging member, the engaging surface, the NT adherents arranged in a pattern on the engaging surface, etc. In a NT3 adhesive system, the adherent 824 includes the engaging member, the engaging surface, the engaging projections, the NT adherent disposed on the engaging surface and projections, etc. Similarly, the adherend 814 may represent a uniform layer applied to a planar receiving sample 812, or it may represent all of the engaging components of either the NTP adhesive system or the NT3 adhesive system described herein.

When a NT adhesive system is tested, the patterned or three-dimensional surfaces of the engaging sample 822 and/or the receiving sample 812 can generally be aligned in any direction relative to the peel direction. For example, a rectangular sample can be cut from the engaging member 22 shown in FIG. 1C such that, once mounted in the T-Peel test apparatus described herein, the peel direction during the test is in the x-direction shown in FIG. 1C. Similarly, a rectangular sample can be cut from the engaging member 22 shown in FIG. 1C such that the peel direction during the T-Peel test is in the y-direction (or any other arbitrary direction in the xy-plane) shown in FIG. 1C. Likewise, a patterned receiving member or a three-dimensional engaging/receiving surface can be sampled to measure the T-Peel force in an arbitrary direction in the xy-plane.

When a T-Peel test value is recited in a given direction, the test criterion is satisfied if the T-Peel test value meets the recited value in at least one direction in the xy-plane of the test sample. For instance, if the NT patterned adhesive system shown in FIG. 1C preferably has a T-Peel test value in a first peel direction of less than 4.7 N/cm, then this test criterion is satisfied if T-Peel test value is less than 4.7 N/cm when an engaging member 22 and a receiving member 24 are peeled apart in at least one direction in the xy-plane as shown in FIG. 1C. When T-Peel test values in multiple directions are recited, the individual directions are only limited insofar as there is a prescribed relationship among the individual directions.

To begin the test, the engaging sample 822 is bonded to the receiving sample 812. Bonding is performed on a flat, clean, rigid surface such as a countertop. The engaging sample 822 is applied to the receiving sample 812 to avoid wrinkles. The adherend 814 fully overlaps the adherent 824. The adherent 824 is centered on the adherend 814 with the longitudinal edges of the adherent 824 being substantially parallel to the longitudinal edges of the adherend 814. The proximal edge 840 of the receiving sample 812 is aligned with the proximal edge 842 of the PET 828. The receiving sample 812 and engaging sample 822 should each extend at least 25 millimeters beyond the bonded portion of the samples such that the proximal edge 840 of the receiving sample 812 and the proximal edge 842 of the PET 828 can be easily placed in the test instrument's grips 850 and 852 (as shown in FIG. 8C). If bonded sample 810 is to be aged, a small piece of release paper 830 (such as a double sided silicone coated paper available as supplier code HV100-473/473 from Fox River Associates, LLC., Geneva, Ill.) is placed between the adherend 814 (adjacent the proximal edge 840) and the adherent 824 (adjacent the proximal edge 842). The release paper 830 should not be inserted more than a few millimeters between the adherend 814 and the adherent 824 (i.e., no more than 10% of the total bonded length). The bonded sample 810 is rolled with a 2 kg (4.5 pound) HR-100 ASTM 80 shore rubber-faced roller. Two full strokes (i.e., back and forth) are applied to the sample at a speed of approximately 10 mm/sec. The bonded area should be approximately 2.54 cm (1 inch) wide by 10.2 cm (4 inch(es)) long (i.e., the same area as the engaging sample). The bonded sample 810 is subjected to an accelerated aging process at a temperature of 60° C. and a pressure of 0.8 N/cm² for a pre-selected length of time prior to testing to provide an aged T-Peel Force. A preferred accelerated aging process time is three days. However, some bonded samples may additionally be tested after aging for longer periods of time such as seven days or shorter periods of time such as six hours.

A skilled artisan should recognize that bonded specimens of other dimensions may be used in the T-Peel Method. The dimensions of the receiving and engaging members may vary from those listed above; however, the effective bonding area should be used to normalize the resultant T-Peel force recorded per inch of bonded width (i.e., the bonded width being the width of the bonded area measured substantially parallel to the grip width once the sample is mounted in the tensile tester).

Materials that already have been incorporated into a commercial product are assumed to have been aged naturally as a result of normal storage and transport. As a result, these materials are not subjected to accelerated aging to simulate real environmental aging. To perform the T-peel test, the material is cut from the product to isolate the adherend and adherent, if possible. However, if the adherend and/or adherent are joined to other materials in a face-to-face configuration, the face-to-face configuration between the adherend and the other material or adherent and the other material should be maintained. The materials should be removed from the product to preserve the integrity of the materials (e.g., adherend and adherent should not be permanently deformed or should not be debonded from each other). Before loading the samples for T-peel test, the receiving and engaging surfaces should be separated approximately 1-5 mm to initiate the peeling. The portion of the sample including the adherend is the receiving sample 812, and the portion of the sample including the adherent is the engaging sample 822. The receiving sample 812 and engaging sample 822 should each extend at least 25 millimeters beyond the bonded portion of the samples such that the proximal edge 840 of the receiving sample 812 and the proximal edge 842 of the engaging sample 822 can be easily placed in the test instrument's grips 850 and 852. If needed, an additional length of 50.8 μm (2 mil) PET film may be attached to the proximal edges 840 and 842 using double sided tape. The T-peel test should be performed on the bonded materials as described in the method below. Furthermore, if the adherent or adherend are elastomeric, the adherent or adherend must be backed with a similar sized sheet of 50.8 μm (2 mil) PET film in order to prevent stretching of the tested substrate.

If the product is not pre-engaged, the materials are cut from the product, and sample preparation would be similar to the method presented above for a sample in a film form. Such samples need to be aged after engagement. If the width of the material is less than 2.54 cm (1 inch), then the weight (during aging) should be chosen such that the net pressure is 0.8 N/cm². The average load calculated in the peel force test should be normalized by the width of the fastener, as described below.

Any of the above-mentioned bonded samples (e.g., materials in a discrete film form after accelerated aging or material in a product) may be refastened. The bonded sample 810 is debonded using the tensile tester and following the test conditions for the T-Peel Test as provided for below (e.g., crosshead speed of twelve inches/minute). The adherent 824 and adherend 814 are refastened in a configuration substantially similar to the configuration in which they were originally attached while avoiding wrinkles. The refastened sample is rolled with a 2 kg (4.5 pound) HR-100 ASTM 80 shore rubber-faced roller. Two full strokes (i.e., back and forth) are applied to the sample at a speed of approximately ten mm/sec (i.e., rolling should take approximately 40 seconds). The T-Peel Test is performed after one minute of dwell time. This is the first refastened T-Peel force. This procedure may be repeated as needed to yield sequential refastened T-Peel forces (i.e., a second refastened T-Peel force, a third refastened T-Peel force, etc.).

The T-Peel test method is performed in a controlled room at 22° C.+/−2° C. and RH 50%+/−10%. Suitable instruments for this test include tensile testers commercially available from Instron Engineering Corp., Canton, Mass. (e.g. Instron 5564) or from MTS Systems Corp., Eden Prairie, Minn. (e.g. Alliance RT/1 or Sintech 1/S). The following procedure illustrates the measurement when using the Instron 5564. The instrument is interfaced with a computer loaded with the Instron® Merlin™ Material Testing Software which controls the testing parameters, performs data acquisition and calculation, and provides graphs and data reports. The instrument is configured with a data acquisition speed of 50 Hz. Any resulting graphs are plotted using the Average Value (integral) setting on the instrument. A load cell is selected so that the forces to be measured will be between 10% and 90% of the capacity of the load cell or the load range used (e.g., typically, a 10N to 100N load cell). The instrument is calibrated to an accuracy of at least 1% and, ideally, less than 0.1% according to the manufacturer's instructions.

The instrument has two grips: a stationary grip 850 and a movable grip 852. The grips 850, 852 used are wider than the sample; typically, 5.08 cm (2 inches) wide grips are used. The grips 850, 852 are air-actuated grips and designed to concentrate the entire gripping force along a plane perpendicular to the direction of testing stress. The distance between the lines of the gripping force (i.e., gauge length) is set to 2.54 cm (1 inch). The load reading on the instrument is zeroed to account for the mass of the fixture and grips. The bonded sample 810 is mounted into the grips 850, 852 as shown in the partial cross-sectional view of FIG. 8C. The bonded sample 810 is mounted so that the proximal edge 840 of the receiving sample 812 is in the movable grip 852 and the proximal edge 842 of the engaging sample 822 is in the stationary grip 850. The bonded sample is mounted such that there is a minimum amount of slack in the receiving sample 812 or engaging sample 822 between the grips. The load cell is zeroed.

The receiving sample 812 is separated from the engaging sample 824 using a crosshead speed of 305 mm/min (12 inches/min). A skilled artisan should recognize that peel angle can affect the peel force. During peeling, the peel angle should be maintained around 180 degrees. An average load is calculated as the average load between about 25 mm (1 inch) and about 88 mm (3.5 inches) displacement. For samples that do not meet the dimensions provided in the Sample Preparation, the average load is calculated from the loads acquired from the crosshead extension between about 25% to about 87.5% of the sample length. For example, if the sample is 15 cm long, the average load is calculated between about 3.75 cm and about 13.1 cm of crosshead extension. The average load is normalized to a unit-width as follows: normalized load (N/cm)=average load (N)÷initial bond width (cm).

Dynamic Shear Test Method

This method is used to determine the shear strength of the bond formed between an adherent and an adherend. The adherent and adherend may be applied uniformly to planar test surfaces, or they may be incorporated into a NT adhesive system disclosed herein. The test may be performed for pre-engaged systems after an accelerated aging process, and/or after refastening the system a predetermined number of times. The dynamic shear test method is performed in the same environmental conditions and with the same instrument as disclosed in the T-Peel Test. The sample preparation for dynamic shear test will vary based on whether the material is available as a discrete web or is incorporated in a product.

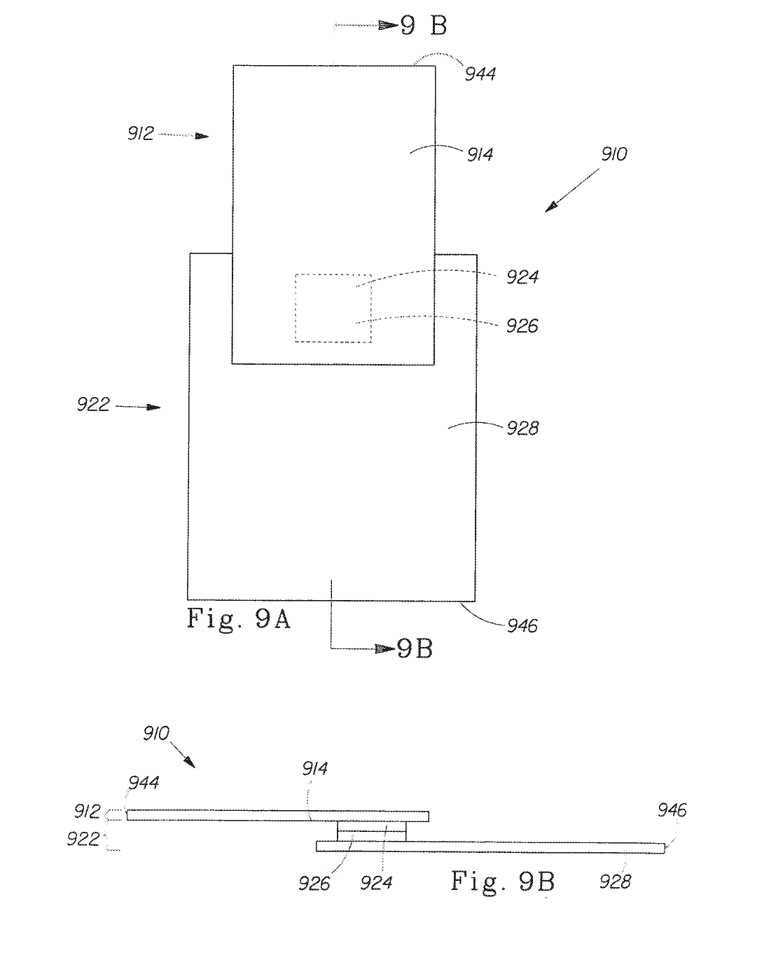

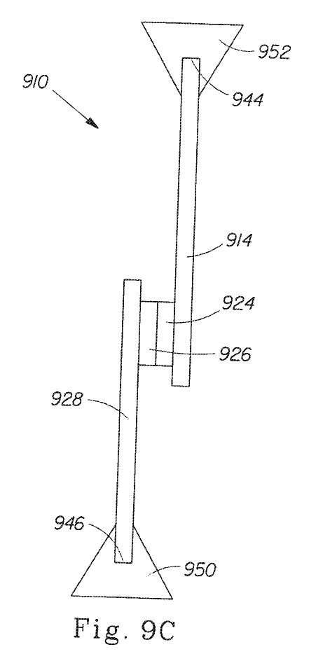

FIGS. 9A-B illustrate a bonded sample 910 formed according to the directions provided below when the material is a discrete web. FIG. 9B is a cross-sectional view taken along sectional line b-b of FIG. 9A.

For a receiving sample 912 having a distal edge 944, an adherend 914 is resized using cutting dies to create rectangular receiving samples with the dimensions of about 3.5 cm (1.4 inches) wide and about 20 cm (7.9 inches) long. In instances where the adherend 914 is the same as an adherent 924, the receiving sample is backed with a like sized piece of poly(ethylene terephthalate) film or paper using double sided tape.

For the engaging sample 922, an approximately 2.54 cm×2.54 cm (1 inch×1 inch) piece of the adherent 924 is bonded in a face-to-face relationship to a similarly sized piece of double-sided tape 926 (such FT 239 available from Avery Dennison Corp., Painesville, Ohio or 9589 available from 3M, St. Paul, Minn.). The adherent 924 and double-sided tape 926 are joined to be substantially coterminous. The adherent 924 is to be wrinkle free. It should be appreciated that the adherent 924/double sided tape 926 laminate can be created with larger sized materials and then resized to about 2.54 cm×2.54 cm. The other side of the double side tape 926 is bonded to a 5.08 cm×12.9 cm (2 inches×6 inches) stainless steel plate 928 such that one side of the adherent 924/double sided tape 926 is approximately 1.27 cm (0.5 inch) from a 5.08 cm (2 inches) wide edge of plate 928. The plate 928 has a distal edge 946 opposite the edge which is adjacent the adherent 924/double sided tape 926 laminate. The adherent 924/double sided tape 926 should be centered along the width of the plate 928.

As described above relative to the T-Peel test, the engaging sample 922 and the receiving sample 912 may represent planar surfaces with uniform layers of adherent/adherend applied thereto. Additionally, the engaging sample 922 and the receiving sample 912 may represent the NT adhesive systems described herein. Similarly, because the NTP adhesive systems and NT3 adhesive systems can exhibit directional dependence in their performance properties, any recited Dynamic Shear test values are satisfied if the test sample meets the recited value when sheared in at least one direction in the xy-plane of the test sample.

The receiving sample 912 is bonded on the engaging sample 922 such that the adherend 914 fully overlaps the adherent 924. The receiving sample 912 is applied so as to avoid wrinkles. The edges of the receiving sample 912 and the edges of the engaging sample 924 are substantially parallel to each other. The receiving sample 912 is bonded to the engaging sample 922 such that the receiving sample 912 extends beyond the plate 928. The bonded sample 910 is configured such that the distal edge 944 of the receiving sample 912 and the distal edge 946 of the plate 928 are opposite one another. The bonded sample 910 is rolled with a 2 kg (4.5 pound) HR-100 ASTM 80 shore rubber-faced roller. Two full strokes (i.e., back and forth) are applied to the sample at a speed of approximately 10 mm/sec. The bonded area should be approximately 2.54 cm×2.54 cm (1 inch×1 inch). The bonded sample 910 is subjected to an accelerated aging process at a temperature of 60° C. and a pressure of 0.8 N/cm² for a pre-selected length of time prior to testing to provide an dynamic shear force. A preferred accelerated aging process time is three days. However, some bonded samples may additionally be tested after aging for longer periods of time such as seven days or shorter periods of time such as six hours.

A skilled artisan should recognize that bonded specimens of other dimensions may be used in the Dynamic Shear Test Method. The dimensions of the receiving and engaging members may vary from those listed above; however, the effective bonding area should be used to normalize the resultant Dynamic Shear force recorded per square inch of bonded area.

Materials that already have been incorporated into a commercial product are assumed to have been aged naturally as a result of normal storage and transport. As a result, these materials are not subjected to accelerated aging to simulate real environmental aging. To perform the dynamic shear test, the material is cut from the product so as to isolate the adherend and adherent, if possible. However, if the adherend and/or adherent are joined to other materials in a face-to-face configuration, the face-to-face configuration between the adherend and the other material or adherent and the other material should be maintained. The materials should be removed from the product to preserve the integrity of the materials (e.g., adherend and adherent should not be permanently deformed or debonded). The adherent is attached to a 5.08 cm×12.9 cm (2 inches×6 inches) stainless steel plate to form an engaging sample. The adherend (already engaged with the adherent) should have a distal edge that extends at least 25 millimeters from the bonded portion of the adherent and adherend such that the distal edge can be easily inserted into the test instrument's grip 952. If the distal edge of the adherend does not extend at least 25 mm, an additional length of 50.8 μm (2 mil) PET film may be attached to the distal edge of the adherend using double sided tape. The Dynamic Shear test should be performed on the bonded materials as described in the method below.

If the product is not pre-engaged, the materials are cut from the product and sample preparation would be similar to the method presented above for a sample in a film form.

Any of the above-mentioned bonded samples (e.g., materials in a discrete film form after accelerated aging or material in a product) may be refastened. A refastened sample is prepared as follows. A bonded sample 910 is manually debonded by peeling the receiving sample 912 from the engaging sample 922. The adherent 924 and adherend 914 are refastened in a configuration substantially similar to the configuration in which they were originally attached while avoiding wrinkles. The bonded sample 910 is configured such that the distal edge 944 of the receiving sample 912 is remote from the distal edge 946 of the plate 928.

The refastened sample is rolled with a 2 kg (4.5 pound) HR-100 ASTM 80 shore rubber-faced roller. Two full strokes (i.e., back and forth) are applied to the sample at a speed of approximately 10 nm/sec. The refastened sample is allowed to sit for one minute of dwell time. Debonding and refastening may be repeated to yield a second refastening, third refastening, etc. The refastened sample may be tested to provide a Dynamic Shear.

The Dynamic Shear test method is performed in a controlled room at 22° C.+/−2° C. and RH 50%+/−10%. The tensile tester is the same as used in the T-Peel test. A load cell is selected so that the forces to be measured will be between 10% and 90% of the capacity of the load cell or the load range used (e.g., typically, a 100 N to 250N load cell). The instrument is calibrated to an accuracy of at least 1% and, ideally, less than 0.1% according to the manufacturer's instructions. The tensile tester has two grips: a stationary grip 950 and a movable grip 952. FIG. 9C is a cross-sectional view of the bonded sample 910 mounted in two grips 950, 952 of the tensile tester. The grips are wider than the adherend 914 or adherent 924 (e.g., typically, about 2.54 cm to 5.08 cm (1 inch to 2 inches) wide). The grips 950, 952 are air-actuated grips and designed to concentrate the entire gripping force along a plane perpendicular to the direction of testing stress. The distal edge 946 of the metal plate 928 is mounted into the stationary grip 950. The distal edge 944 receiving sample 912 is mounted into the movable grip 952. The bonded sample is to be mounted into the grips 950, 952 so that there is a minimum amount of slack and the load measured is less than 0.5 N. The distance between the lines of the movable grip 952 and the proximate edge of the bond site is about 3.3 cm (1.3 inches). The load reading on the instrument is zeroed.

The receiving sample 912 is separated from the engaging sample 924 using a crosshead speed of 305 mm/min (12 inches/min) until the two samples are completely disengaged or one of the bonded sample 910 fails (e.g., the engaging sample tears, the receiving sample tears, or the sample debonds at an interface other than of that between the engaging sample and the receiving sample). If the bonded sample fails at any location other than the interface between the adherend and adherent prior to reaching a maximum load of at least 0.8 N/cm² (5 N/in²), the data is to be discarded and another sample must be run using a backing material to prevent the sample from tearing and/or using a stronger double sided tape.

The maximum load is recorded and normalized per unit area to provide the Dynamic Shear force as follows: normalized load (N/cm²)=measured load (N)∓bonded area (cm²).

Shear Hang Time Test Method

The Shear Hang Time test method is used to determine the shear resistance, measured as a length of time, of the bond formed between an adherent and an adherend when the bond is subjected to a load in controlled temperature environments. The adherent and adherend may be applied uniformly to planar test surfaces, or they may be incorporated into a NT adhesive system disclosed herein. The test may be performed for pre-engaged systems after an accelerated aging process, and/or after refastening the system a predetermined number of times. This test is derived from FINAT Test Method No. 8, the European Association for the Self Adhesive Tape Industry (AFERA) Test Method No. 4012, and ASTM-D Test Method No. 6463. The sample preparation for Shear Hang Time test will vary based on whether the material is available as a discrete web or is incorporated in a product.

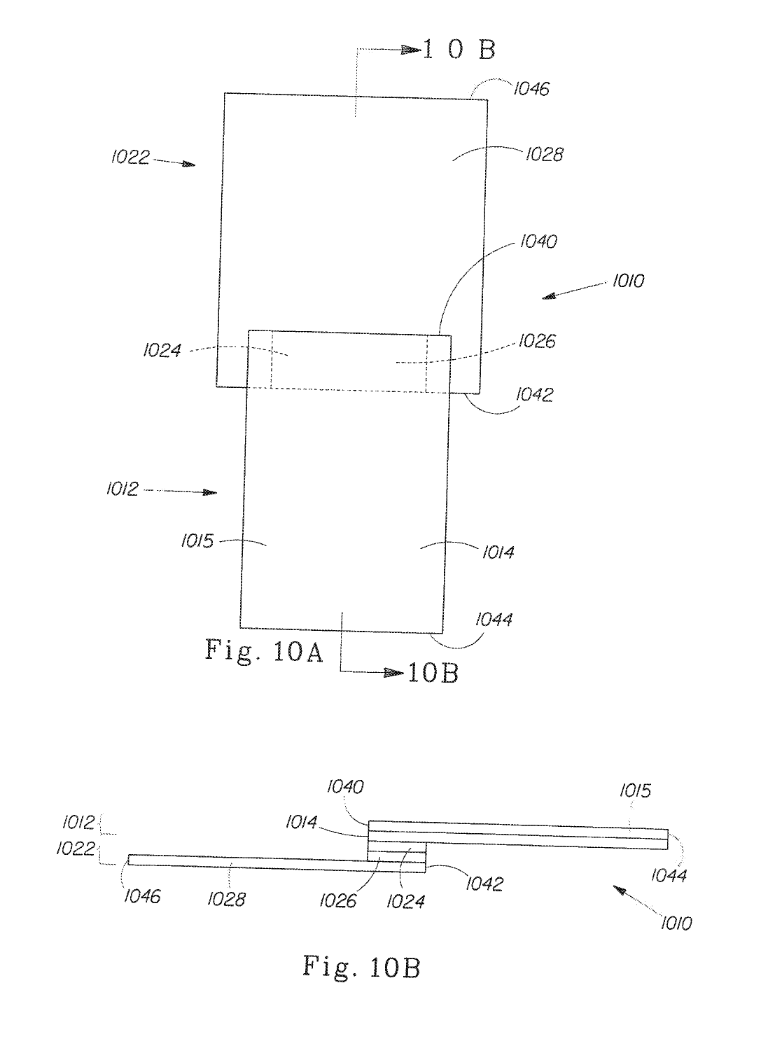

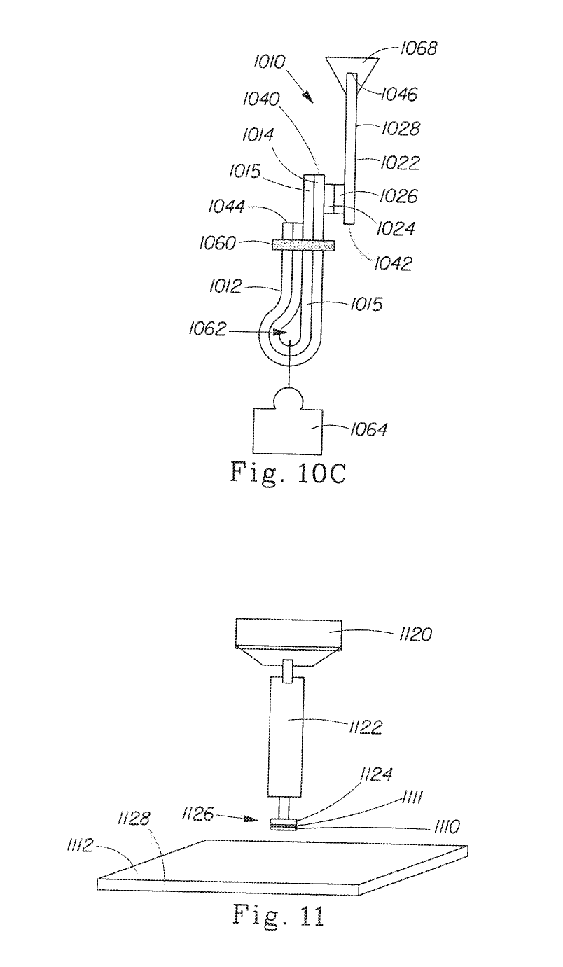

FIGS. 10A and 10B illustrate a bonded sample 1010 formed according to the directions provided below when the material is a discrete web. FIG. 10B is a cross-sectional view taken along sectional line b-b of FIG. 10A

For a receiving sample 1012 having a proximal edge 1040 and a distal edge 1044, an adherend 1014 is resized using cutting dies to create a rectangular sample with the dimensions of about 3.5 cm×7.5 cm (1.4 inches×3.0 inches). The adherend 1014 is backed with a like sized backing sheet 1015 of poly(ethylene terephthalate) film or paper. The backing sheet 1015 must be positioned and sized so as to not interfere with the adherend 1014 to the adherent 1024 interface.

For the engaging sample 1022, an approximately 1.27 cm×2.54 cm (0.5 inch×1 inch) piece of an adherent 1024 is bonded in a face-to-face relationship to a similarly sized piece of double-sided tape 1026 (such as FT 239 available from Avery Dennison Corp., Painesville, Ohio or 9589 available from 3M, St. Paul, Minn.). The adherent 1024 is to be wrinkle free. It should be appreciated that the adherent 1024/double sided tape 1026 laminate can be created with larger sized materials and then resized to 1.27 cm×2.54 cm (0.5 inch×1 inch). The other side of the double side tape 1026 is bonded to a test panel 1028 having a proximal edge 1042 and a distal edge 1046. The double side tape 1026 is bonded adjacent the proximal edge 1042 of the test panel 1028. The test panel 1028 is ideally made from steel (ASTM A666 specification); alternately, the test panel 1028 may be made from a corrugated cardboard with a thickness of at least about 3 mm to 4 mm. The adherend 1014 is bonded onto the adherent 1024. The bonded sample 1010 is then rolled with a 2 kg (4.5 pound) HR-100 ASTM 80 shore rubber-faced roller. Two full strokes (i.e., back and forth) are applied to the sample 1010 at a speed of approximately 5 mm/sec. The bonded area should be approximately 1.27 cm×2.54 cm (0.5 inch×1 inch). The bonded sample 1010 is preferably subjected to an accelerated aging process at a temperature of 60° and a pressure of 0.8 N/cm² for at least 3 days prior to testing, although longer or shorter periods aging are possible.

As described above relative to the T-Peel test, the engaging sample 1022 and the receiving sample 1012 may represent planar surfaces with uniform layers of adherent/adherend applied thereto. Additionally, the engaging sample 1022 and the receiving sample 1012 may represent the NT adhesive systems described herein. Similarly, because the NTP adhesive systems and NT3 adhesive systems can exhibit directional dependence in their performance properties, any recited Shear Hang Time test values are satisfied if the test sample meets the recited value when sheared in at least one direction in the xy-plane of the test sample.

A skilled artisan should recognize that bonded specimens of other dimensions may be used in the Shear Hang Time Test Method. The dimensions of the receiving and engaging members may vary from those listed herein. However, if the bonded area exceeds approximately 1.27 cm×2.54 cm (0.5 inch×1 inch), the sample should be resized to yield a bonded area of 1.27 cm×2.54 cm (0.5 inch×1 inch).

Materials that already have been incorporated into a commercial product are assumed to have been aged naturally as a result of normal storage and transport. As a result, these materials are not subjected to accelerated aging to simulate real environmental aging. To perform the dynamic shear test, the material is cut from the product so as to isolate the adherend and adherent, if possible. However, if the adherend and/or adherent are joined to other materials in a face-to-face configuration, the face-to-face configuration between the adherend and the other material or adherent and the other material should be maintained. The materials should be removed from the product to preserve the integrity of the materials (e.g., adherend and adherent should not be permanently deformed and should not be debonded from each other). The adherent is attached via double sided tape to a test panel 1028 to form an engaging sample. The adherend (already engaged with the adherent) should have a distal edge that extends at least 50 mm from the bonded portion of the adherent and adherend such that the distal edge can be easily be folded over to form a loop 1062. If the distal edge does not extend at least 50 mm, an additional length of 50.8 μm (2 mil) PET film may be attached to the distal edge 1044 using double sided tape. The shear hang test should be performed on the bonded materials as described in the method below.

If the product is not pre-engaged, the materials are cut from the product and sample preparation would be similar to the method presented above for a sample in a film form.

Any of the above mentioned bonded samples (e.g., materials in a discrete film form after accelerated aging or material in a product) may be refastened. A refastened sample is prepared as follows. A bonded sample 1010 is manually debonded by peeling the receiving sample 1012 from the engaging sample 1022. The adherent 1024 and adherend 1014 are refastened in a configuration substantially similar to the configuration in which they were originally attached while avoiding wrinkles. The bonded sample is rolled with a 2 kg (4.5 pound) HR-100 ASTM 80 shore rubber-faced roller. Two full strokes (i.e., back and forth) are applied to the sample at a speed of approximately 5 mm/sec. The refastened sample is allowed to sit for 1 minute of dwell time. Debonding and refastening may be repeated to yield a second refastening, third refastening, etc. The refastened sample may be tested to provide a Shear Hang Time.

The bonded sample 1010 is prepared at ambient room conditions (e.g., 22° C.+/−2° C. and RH 50%+/−10%). The bonded sample 1010 is brought into a temperature chamber immediately prior to the commencement of testing. The time between introduction of the bonded sample 1010 into the temperature chamber and commencement of testing is to be less than 5 minutes. The test is conducted in a temperature chamber or oven maintained at about 38° C.±2° C. (100° F.±4° F.). Suitable instruments for this test are the RT10 or RT30 available from ChemInstruments Inc, Fairfield, Ohio or any apparatus having a rack or jig capable of holding a test plate within 0° to 2° of vertical. The time is measured by an automated timer capable of reading to the nearest minute.

FIG. 10C is a cross-sectional view of the bonded sample 1010 in a test apparatus. The distal edge 1044 of the adherend receiving sample 1012 is folded onto itself and affixed with a staple 1060 to form a loop 1062. The distal edge 1046 of the engaging sample 1022 is placed into the rack 1068 so that the receiving sample 1012 hangs downwards. A 1 kg weight 1064 is attached to the free end of the receiving sample 1012 and may be hooked or engaged through the loop 1062 formed in the adherend 1014. The timer is started once the weight 1064 hangs freely from the receiving sample 1012. The time required for debonding of the adherend 1014 and the adherent 1024 is recorded (i.e., the receiving member 1012 separates and falls from the engaging member 1022). The test can be manually stopped if the sample remains bonded beyond a prescribed time period.

If the bonded sample fails for some reason other than separation of the interface between the engaging sample and the receiving sample (e.g., the engaging sample tears, the receiving sample tears, or the sample debonds at an interface other than of that between the engaging sample and the receiving sample), the data is discarded and another sample must be run using a backing material to prevent the sample from tearing and/or using a stronger double sided tape to prevent separation at interfaces other than between the engaging sample and the receiving sample.

Probe Tack Test Method

This method is used to determine the tackiness of select adherents and adherends when placed in contact with a standard surface at a controlled rate and pressure. This test is derived from ASTM D Test Method No. 2979-01 which is directed to pressure-sensitive adhesives. FIG. 11 depicts a suitable sample and instrument configuration.

For the Instron 5564 instrument listed above, the sample is prepared as follows. The sample material 1110 is bonded to a piece double sided tape 1111 (such as FT 239 available from Avery Dennison Corp., Painesville, Ohio). The sample material 1110 and double sided tape 1111 are resized to 2.54 cm×2.54 cm (1 inch×1 inch). The opposite side of the double sided tape 1111 is bonded to the anvil face 1126 of a probe anvil 1124. The sample material 1110/double sided tape 1111 is cut with a knife to fit to the anvil face 1126 (about 1.1 cm in diameter, as described below). The sample material 1110/double sided tape 1111 is to be cut without contaminating or touching the surface of the sample material 1110 to be tested. The surface area of the sample material 1110 is approximately the same as the anvil face 1126. If the sample material 1110 is engaged with another material, the sample material 1110 is to be separated from the other material prior to testing. The adherent and adherend are tested.

The Probe Tack Test is performed in a controlled room at 22° C.+/−2° C. and RH 50%+/−10%. Suitable instruments for this test include tensile testers commercially available from Instron Engineering Corp., Canton, Mass. (e.g. Instron 5564) or equivalent tensile testers.

The instrument is interfaced with a computer which controls the testing parameters, performs data acquisition and calculation, and provides graphs and data reports. The probe anvil 1124 is mounted to a probe body 1122 which is connected to a load cell 1120. The probe anvil 1124 is cylindrical is shape and has a substantially circular anvil face 1126. The anvil face 1126 has a diameter of approximately 1.1 cm and a surface area of 0.95 cm². The load cell 1120 is selected so that the forces to be measured will be between 10% and 90% of the capacity of the load cell 1120. The bottom stationary side of the Instron is mounted with a fixed planar plate 1128 with a predominate surface parallel to the anvil face 1126. The plate 1128 is made from a material that will exhibit a negligible degree of deformation or compression during the test (e.g., a steel plate). A standard surface 1112 is joined to the plate 1128. For purposes of this test method, the standard surface 1112 is a mimic skin available from IMS, Inc. (Orange, Conn.) as VITRO-SKIN N-19. Before testing, the mimic skin is conditioned according to the supplier's instruction. The mimic skin is bonded to the plate 1128 to maintain the mimic skin a substantially planar configuration during testing.

Before measurement, the load reading on the instrument is zeroed to account for the mass of the probe. The anvil face 1126 along with the sample material 1110 are brought into contact with the standard surface 1112 at speed of 1 mm/min until a compression load of 95 gf (i.e., corresponding to 9.79 kPa, for a probe 1.1 cm in diameter) is achieved. After a 1 second delay while maintaining the 95 gf, the probe is pulled away from the standard surface at speed of 10 mm/min. The maximum load is then recorded as gram-force. The maximum load is normalized per unit area of the anvil to provide the Probe Tack value as follows: normalized load (i.e., Probe Tack value in grams-force/cm²)=measured maximum load (gf)÷anvil face surface area (cm²).

A surface exhibits low surface adhesion (i.e., it is non-tacky) if it has a measurement of less than 50 grams force (gf) according to the Probe Tack Test. In certain embodiments, low surface adhesion may be less than 40 gf/cm²; alternately, less than 30 gf/cm²; alternately, less than 20 gf/cm²; alternately, less than 10 gf/cm²; or alternately, less than 5 gf/cm². Kraton® D1102 and Kraton® D1111 (available from Kraton Polymers, Houston, Tex.) exhibit a probe tack force of about 2 gf. Vectors 4211 (available from Dexco Polymers, Houston, Tex.) exhibits a probe tack force of about 2 gf/cm². By way of comparison, Kraton® D1107 (available from Kraton Polymers, Houston, Tex.) exhibits a probe tack force of about 168 gf/cm².

Simulated Contamination Sample Preparation

Samples analyzed by the foregoing test methods should generally have contamination-free adherent and adherend surfaces to improve the repeatability of the test results. However, non-tacky adhesive systems are subject to human and/or environmental contamination during actual use. Thus, it can be beneficial to characterize the diminishing adhesive effect on the non-tacky adhesive systems in a controlled manner to determine the effect, if any, that routine contamination is likely to have on a particular NT adherent/NT adherend pair. This simulated contamination sample preparation procedure can be used in connection with any of the foregoing test methods to quantify this diminishing adhesive effect.

A simulated contaminating surface is prepared by first attaching a 2.54 cm×20.32 cm sample of a synthetic skin substrate to a sheet of release paper (such as a double sided silicone coated paper available as supplier code HV100-473/473 from Fox River Associates, LLC., Geneva, Ill.). A suitable synthetic skin substrate that contains, e.g., proteins and lipids similar to human skin is available under the name VITRO-SKIN N-19 (available from IMS, Inc., Orange, Conn.). Vitro-skin is used as it is (non-hydrated) for the contamination study.

A baby wipe, which is available under the name PAMPERS Lavender Wipes (available from The Procter and Gamble Company, Cincinnati, Ohio), is first folded into quarters (lengthwise in the cross direction), and then stretched from it's original length to a length of 25.4 cm (in the cross direction). The baby wipe used for contamination purpose has a net weight of about 8.5 g to about 9.5 g. The baby wipe provides a source of contaminants (such as water, lotion, etc.) that are likely to be transferred to a caregiver's fingers when, for example, a baby is cleaned with the wipe. The contaminants transferred to the caregiver's fingers could then be transferred to adherent and adherend surfaces that are used to seal a diaper that is subsequently put onto the baby.

The folded and stretched baby wipe is then laid upon the skin mimicking surface of synthetic skin and a second piece of release paper is used to cover the baby wipe. The use of release paper is to avoid transfer of contaminants to any other surface than the synthetic skin. The baby wipe and synthetic skin are pressed together using a HR-100 ASTM roller (2 kg) for a total of 40 seconds and two full strokes (i.e., twice forward and twice backward with 10 seconds for each pass). The baby wipe and its covering layer of release paper are then disengaged from the synthetic skin.

Any adherent/adherend surfaces that are to be contaminated by the simulated contaminating surface (i.e., the synthetic skin) are placed in contact with (facing) the contaminated side of the synthetic skin for a total of 5 seconds under a pressure of 0.8 N/cm². Unless otherwise stated, both the adherent and adherent surfaces are treated with the synthetic skin in a simulated contamination sample preparation procedure. The contaminated samples prepared this way can be used with any of the foregoing test methods to quantify this diminishing adhesive effect.

### EXAMPLES

Various materials were tested to determine the resulting T-Peel force when two opposing planar surfaces were uniformly coated with different adherent/adherend combinations. Samples of the combinations were tested according to the T-Peel Test Method, and the resulting peel forces (in N/cm) for the combinations are summarized in Table 1. The samples were aged at a temperature of 60° C. and under 0.8 N/cm² pressure prior to testing. The samples were aged for durations of 6 hours, 3 days, and/or 1 week, as indicated in Table 1. The reported peel force is an average from at least 3 samples. Absence of an entry in Table 1 indicates that the particular adherent/adherend combination was not tested.

The materials in the following examples are referenced by the acronyms provided below.

D1102: Kraton® D1102 is available from Kraton Polymers, Houston, Tex. D1102 is a styrene/butadiene/styrene triblock elastomer (16% diblock and 28% styrene). D1102 is extruded to form about a 51 μm to 127 μm (2 mil to 5 mil) thick film.

D1111: Kraton® D1111 is available from Kraton Polymers, Houston, Tex. D1111 is a styrene/isoprene/styrene triblock elastomer (15% diblock and 22% styrene). D1111 is extruded to form about a 51 μm to 127 μm (2 mil to 5 mil) thick film.

4211: Vector® 4211 is available from Dexco Polymers LP, Houston, Tex. 4211 is a styrene/isoprene/styrene triblock elastomer (0% diblock and 20% styrene). 4211 is extruded to form about a 51 μm to 127 μm (2 mil to 5 mil) thick film.

8508: Vector® 8505 is available from Dexco Polymers LP, Houston, Tex. 8505 is a styrene/butadiene/styrene triblock elastomer (0% diblock and 29% styrene). 8508 is extruded to form about a 51 μm to 127 μm (2 mil to 5 mil) thick film.

PET: PET is a corona treated, bi-axial oriented poly(ethylene terephthalate) available under tradename Hostanphan® RNK-C from Mitsubishi Polyester Film GmbH, Wiesbaden, Germany. The PET is supplied as a 12 microns thick film.

oPA54: oPA54 is a bi-oriented polyamide film having a supplier reported surface energy of 54 mN/m. The bi-oriented polyamide film is 15 microns thick and is available from CFP Flexible Packaging S.p.A., Italy, under the tradename Emblem™ 1500.

oPA40: oPA40 is bi-oriented polyamide film having a supplier reported surface energy of 40 mN/m. The bi-oriented polyamide film is the untreated side of the oPA54 Emblem™ film. oPA40 is supplied as a film 15 microns thick.

PE50: PE50 is the corona treated side of a polyethylene film manufactured by Nordenia International AG as supplier code KC 2672.770. PE50 has a thickness of 95 microns and a supplier reported surface energy of 50 mN/m. PE50 has a density of 0.93 g/cm³.

PE33: PE33 is the untreated side of the PE50 polyethylene film manufactured by Nordenia International AG. PE33 has a supplier reported surface energy of 33 mN/m.

PP44: PP44 is the corona treated side of a polypropylene film having a supplier reported surface energy of 44 mN/m available as supplier code 14461 from Huhtamaki GmbH, Forchheim, Germany. PP44 has a thickness of 70 microns and a density of 0.9 g/cm³.

PP33: PP33 is the untreated side of the PP44 polypropylene film manufactured by Huhtamaki GmbH, Forchheim, Germany. PP33 has a surface energy of 33 mN/m.

oPP42: oPP42 is a bi-oriented polypropylene film double coated with acrylic and is manufactured by ExxonMobil Inc., Luxembourg under the trade name MW 647 OPPalyte™. oPP42 has a supplier reported surface energy of 42 mN/m and a thickness of 40 microns.

TABLE 1

| | | Adherent | | | |
|---|---|---|---|---|---|
| | | D1102 | D1111 | 4211 | 8508 |
| Adherend | PET | 2.6 ± 0.08 (6 h) | 1.0 ± 0.2 (6 h) | 3.1 ± 0.04 (6 h) | 2.1 ± 0.4 (6 h) |
| | | 3.1 ± 0.08 (3 d) | 2.4 ± 0.008 (3 d) | 5.4 ± 1.2 (3 d) | 3.2 ± 0.08 (3 d) |
| | | 3.1 ± 0.2 (1 w) | 3.5 ± 0.08 (1 w) | 6.3 ± 1.6 (1 w) | |
| | oPA54 | 2.0 ± 0.2 (6 h) | 1.7 ± 0.7 (6 h) | 1.7 ± 0 (6 h) | |
| | | 1.9 ± 0.2 (3 d) | 2.4 ± 0.2 (3 d) | Lock Up (3 d) | |
| | | 2.3 ± 0.2 (1 w) | 3.1 ± 2.0 (1 w) | | |
| | OPA40 | 1.2 ± 0.04 (6 h) | 0.7 ± 0.4 (6 h) | 1.4 ± 0.08 (6 h) | |
| | | 1.7 ± 0.1 (3 d) | 2.6 ± 0.3 (3 d) | 2.4 ± 0.4 (3 d) | |
| | | 2.0 ± 0.1 (1 w) | | 2.3 ± 0.5 (1 w) | |
| | PE50 | 4.7 ± 0.1 (6 h) | 1.2 ± 0.9 (6 h) | 2.7 ± 0.2 (6 h) | |
| | | 4.3 ± 0.4 (3 d) | 3.5 ± 0.2 (3 d) | Lock Up (3 d) | |
| | PE33 | 0.9 ± 0.04 (6 h) | 0.2 ± 0.3 (6 h) | 0.2 ± 0.08 (6 h) | |
| | | 0.9 ± 0.0 (3 d) | 3.1 ± 0.4 (3 d) | 0.6 ± 0.08 (3 d) | |
| | PP33 | 3.5 ± 0.04 (6 h) | 1.2 ± 1.2 (6 h) | 2.9 ± 0.3 (6 h) | |
| | | 4.7 ± 0.1 (3 d) | 3.7 ± 0.2 (3 d) | 4.9 ± 0.1 (3 d) | |
| | PP44 | 3.5 ± 0.1 (6 h) | 2.1 ± 0.6 (6 h) | 3.3 ± 0.3 (6 h) | |
| | | 5.4 ± 0.04 (3 d) | 5.5 ± 0.8 (3 d) | Lock Up (3 d) | |
| | | | 6.7 ± 2.0 (1 w) | | |
| | oPP42 | Lock Up (6 h) | 1.7 ± 0.4 (6 h) | Lock Up (6 h) | |
| | | | 3.1 ± 0.4 (3 d) | | |
| | D1111 | | 1.9 ± 0.2 (6 h) | | |
| | | | 4.2 ± 0.3 (3 d) | | |
| | | | 6.7 ± 0.4 (1 w) | | |
| | 4211 | | | Lock Up (6 h) | |
| | 8508 | | | | Lock Up (6 h) |

### Examples 1-4

For Example 1, test samples including a D1102 NT adherent and a PET NT adherend, both uniformly applied to planar test surfaces, were prepared and analyzed. The D1102 adherend is supplied in pellet-form and was extruded into about a 76 μm (3 mil) thick film. The D1102 adherent is a styrene/butadiene/styrene triblock elastomer having 16% diblock, and 28% styrene. The weight average molecular weight of the D1102 adherent was determined to be 71 kDa (determined by gel permeation chromatography using polystyrene standards in tetrahydrofuran). The D1102 adherent has a supplier-reported melt flow rate of 6 g/10 min (as measured by ISO method 1133 at the conditions of 200° C./5 kg).

Test samples for Example 2 were prepared in the same way as Example 1, except that the oPA54 NT adherend was used in place of PET.

Test samples for Example 3 were prepared in the same way as Example 1, except that the oPA40 NT adherend was used in place of PET.

For Example 4, test samples including a 4211 NT adherent and a oPA40 NT adherend, both uniformly applied to planar test surfaces, were prepared and analyzed. The 4211 adherend is supplied in pellet-form and was extruded into about a 76 μm (3 mil) thick film. The weight average molecular weight of the 4211 adherent was determined to be 86 kDa (determined by gel permeation chromatography using polystyrene standards in tetrahydrofuran). The 4211 adherend has a supplier-reported melt flow rate 12 g/10 min (as measured ASTM method D 1238 at the test conditions of 200° C./5 kg).

Test Results

Table 2 provides the T-Peel test results for Examples 1-4 subjected to aging for either 6 hours, 3 days, or 1 week and at a temperature of 60° C. under 0.8 N/cm² pressure. The T-Peel force is an average from at least 3 samples. As can be seen from Table 2, the T-Peel force plateaus over time. The T-Peel force after 1 week of aging does is not appreciably greater than the T-Peel force measured after 3 days of aging. The data shows less than about a 20% increase in T-Peel force from 3 days of aging to 1 week of aging.

TABLE 2

T-Peel Force (N/cm)

| | 6 hours | 3 days | 1 week |
|---|---|---|---|
| Example 1 | 2.6 ± 0.08 | 3.1 ± 0.08 | 3.1 ± 0.2 |
| Example 2 | 2.0 ± 0.2 | 1.9 ± 0.2 | 2.2 ± 0.2 |
| Example 3 | 1.2 ± 0.04 | 1.7 ± 0.1 | 2.0 ± 0.1 |
| Example 4 | 1.4 ± 0.08 | 2.4 ± 0.4 | 2.2 ± 0.5 |

Table 3 provides the T-Peel test results for Examples 1-4 subjected to 1 week of aging at a temperature of 60° C. under 0.8 N/cm² pressure and one or more refastening events (1, 2, or 3 times with a 1 minute dwell time after refastening). As can be appreciated, the T-Peel force does not appreciably degrade over the refastening events. The T-Peel force of a sample after 3 refastening events is not more than about 0.4 N/cm less than the T-Peel force for the same sample after 1 refastening event.

TABLE 3

T-Peel Force (N/cm)

| | 1st refasten | 2nd refasten | 3rd refasten |
|---|---|---|---|
| Example 1 | 1.5 ± 0.1 | 1.4 ± 0.1 | 1.3 ± 0.08 |
| Example 2 | 1.6 ± 0.2 | 1.6 ± 0.08 | 1.5 ± 0.08 |
| Example 3 | 1.5 ± 0.1 | 1.4 ± 0.1 | 1.3 ± 0.08 |
| Example 4 | 1.7 ± 0.2 | 1.7 ± 0.2 | 1.7 ± 0.2 |

Table 4 provides the Dynamic Shear Test results for Examples 1-4 subjected to aging for 1 week or 3 days at a temperature of 60° C. under 0.8 N/cm² pressure. Table 4 also provides the Dynamic Shear for Examples 1-4 both prior to refastening and after three refastening events.

TABLE 4

Dynamic Shear (N/cm²)

| | prior to refastening | after 3 refastenings |
|---|---|---|
| Example 1 | 15 ± 2.0 (1 w) | 14 ± 1.7 (1 w) |
| Example 2 | 13 ± 0.3 (1 w) | 15 ± 0.3 (1 w) |
| Example 3 | 12 ± 1.1 (1 w) | 10 ± 0.8 (1 w) |
| Example 4 | 11 ± 1.1 (1 w) | 10 ± 0.9 (1 w) |
| | 20 ± 0.8 (3 d) | 18 ± 0.9 (3 d) |

Table 5 provides the Shear Hang Time Test results for Examples 1-4 subjected to 3 days of aging at a temperature of 60° C. under 0.8 N/cm² pressure, both prior to refastening and after three refastening events. A value of “pass” indicates that the sample remained attached for at least 240 minutes.

TABLE 5

Shear Hang Time

| | prior to refastening | after 3 refastenings |
|---|---|---|
| Example 1 | Pass | Pass |
| Example 2 | Pass | Pass |
| Example 3 | Pass | Pass |
| Example 4 | Pass | Pass |

### Examples 5-6

For Examples 5 and 6, test samples including a 4211 NT adherent and a oPA40 NT adherend, both uniformly applied to planar test surfaces as films, were prepared and analyzed. Both examples were tested according to the T-Peel test (after being aged for 3 days and at a temperature of 60° C. under 0.8 N/cm² pressure) to determine the peel force required after the first engagement (i.e., prior to any refastening) and after the first refastening of the adherent/adherend system. For Example 5, no simulated contamination procedure was used prior to the T-Peel test. For Example 6, the simulated contamination procedure was used to contaminate both the adherent and adherend surfaces after the first engagement, but before the first refastening.

Table 6 provides the comparative results for the simulated contamination procedure. The T-Peel forces represent an average from 4 samples. As is apparent from Example 6, human fingers can contaminate and drastically reduce the adhesive effect of an adherent/adherend pair. When a given adherent/adherend pair is particularly susceptible to contamination, it would be desirable to use a NT3 adhesive system, whose non-planar three-dimensional surface can structurally inhibit contact of potential contaminants with at least portions of the adhesive surfaces.

TABLE 6

T-Peel Force (N/cm)

| | prior to refastening | after 1 refastening |
|---|---|---|
| Example 5 | 1.4 ± 0.07 | 1.1 ± 0.03 |
| Example 6 | 1.4 ± 0.07 | 0.22 ± 0.07 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A non-tacky patterned adhesive system comprising:
(a) an engaging member having an engaging surface comprising a first non-tacky adherent disposed thereon,
(b) a receiving member having a receiving surface comprising a first non-tacky adherend disposed thereon;
wherein the non-tacky adherent and non-tacky adherend are selected from the group consisting of selective adhesives, cohesives, and a combination thereof; and
wherein one or more of the non-tacky adherent and non-tacky adherend are patterned.

2. The non-tacky patterned adhesive system of claim 1, wherein one or more of the non-tacky adherent and non-tacky adherend are three-dimensional.

3. The non-tacky patterned adhesive system of claim 1, wherein the non-tacky adherent(s) are selected from the group consisting of styrenic block copolymers, poly(ethylene terephthalate) and oriented poly(ethylene terephthalate), polyamide s and oriented polyamides, polyisoprene, natural and synthetic rubber, polyolefins, and combinations thereof.

4. The non-tacky patterned adhesive system of claim 1, wherein the non-tacky adherend(s) are selected from the group consisting of styrenic block copolymers, poly(ethylene terephthalate) and oriented poly(ethylene terephthalate), polyamides and oriented polyamides, polyisoprene, natural and synthetic rubber, polyolefins, and combinations thereof.

5. The non-tacky patterned adhesive system of claim 1, wherein the non-tacky adherent and the non-tacky adherend, after aging for three days at a temperature of 60° C. and a pressure of 0.8 N/cm², exhibit a T-Peel test value of less than about 8.7 N/cm when applied uniformly to planar test surfaces.

6. The non-tacky patterned adhesive system of claim 1, wherein at least one of the non-tacky adherent, and the non-tacky adherend is modified by a high surface energy treatment.

7. The non-tacky patterned adhesive system of claim 1, wherein the non-tacky patterned adhesive system is a fastener for a disposable absorbent article.

8. The non-tacky patterned adhesive system of claim 1, wherein the non-tacky patterned adhesive system is a fastener for a reclosable bag.

9. The non-tacky patterned adhesive system of claim 1, wherein the non-tacky patterned adhesive system is a fastener for a two-component tape.

10. The non-tacky patterned adhesive system of claim 1, wherein the non-tacky patterned adhesive system is a fastener for a two-component system.

11. The non-tacky patterned adhesive system of claim 1, wherein either non-tacky adherent or non-tacky adherend is selected from the group consisting of styrenic block copolymers, polyisoprene, natural and synthetic rubber, and combinations thereof.
